(19) United States
(12) Patent Application Publication
(10) Pub. No.: US 2026/0262655 A1
(43) Pub. Date: Sep. 10, 2026

(54) INHIBITION OF SEED GERMINATION USING A COMBINATION OF BIOLOGICAL AND CHEMICAL INHIBITORS OF ETHYLENE

(71) Applicant: Verdesian Life Sciences U.S., LLC, Cary, NC (US)

(72) Inventors: Amy Burton, Fuquay-Varina, NC (US); Kuide Qin, Chapel Hill, NC (US)

(21) Appl. No.: 19/166,104

(22) PCT Filed: Mar. 19, 2024
(86) PCT No.: PCT/US2024/020490

§ 371 Date: Sep. 17, 2025

Related U.S. Application Data
(60) Provisional application No. 63/453,269, filed on Mar. 20, 2023.

(51) Int. Cl. A01N 63/27; A01N 27/00; A01P 13/02; A01P 21/00

(52) U.S. Cl. CPC A01N 63/27; A01N 27/00; A01P 13/02; A01P 21/00

(57) ABSTRACT

The present disclosure relates to compositions comprising an ethylene biosynthesis inhibitor and an ethylene receptor blocker in herbicidally effective amounts that can be employed in agricultural applications where the ethylene biosynthesis inhibitors are biological inhibitors such as bacterial Pseudomonas fluorescens strain D7, while the ethylene receptor blockers are chemical compounds such as 1-Methylcyclopropene (1-MCP).

### TECHNICAL FIELD

The present disclosure relates to bioherbicide compositions comprising a bacterial biosynthesis inhibitor and an ethylene receptor blocker in herbicidally effective amounts, and the use of such compositions to control the growth of invasive weeds such as cheatgrass. More particularly, the bioherbicide composition contains a strain of Pseudomonas fluorescens bacteria and an ethylene receptor blocker.

### BACKGROUND

Invasive weeds are a widespread problem in many parts of the world. For example, in the United States it is estimated that over 100 million acres of public and private lands are invested with cheatgrass (Bromus tectorum), which is listed as a noxious weed in 46 states. In the Western United States, cheatgrass has invaded public and private rangelands, pastures, and broadacre row cropping systems. Due to its adaption to a wide range of annual precipitation and soil conditions, there is now little in the natural ecosystem to contain its spread.

In addition, Cheatgrass produces an extensive root system that outcompetes many native plants for nutrients and water and is able to grow into the winter season. By late spring or early summer, it is generally dried out and provides fuel for wildfires to clear established native plants, making room for more cheatgrass to seed. Thus, cheatgrass is not only bad for ranchers and farmers who battle this invasive weed every year, but is also one of the major causes of wildfires in the Western United States.

In the past, selective herbicides have been the primary method of removing cheatgrass, because they are desirable for their ability to target specific plant species or groups. Though some herbicides can be effective against cheatgrass, they only take out the existing plants, leaving seeds in the soil that will grow and need to be sprayed the following year. Thus, while selective herbicides and many other approaches have been used in an attempt to control invasive grass weeds, so far, none have had widespread success.

Thus, what is needed in the art are compositions and methods that permit control of invasive grass weeds without negatively affecting native plants or crops, or changing the soil ecosystem, thereby allowing for preservation and restoration of habitats and increased agricultural productivity.

### SUMMARY

In accordance with the purpose(s) of the currently disclosed subject matter, as embodied and broadly described herein, in one aspect relates to a composition comprising a bioherbicide composition comprising a strain of Pseudomonas fluorescens bacteria; and an ethylene receptor blocker, wherein the strain of Pseudomonas fluorescens bacteria and the ethylene receptor blocker are present in herbicidally effective amounts.

In another aspect, the subject matter described herein is directed to a method of controlling the growth of invasive grass weed in a target area, the method comprising: (i) applying to the target area a herbicidally effective amount of a bioherbicide composition as disclosed herein.

In another aspect, the subject matter described herein is directed to a method of reducing the germination of an invasive grass weed in a target area, the method comprising applying to the target area a herbicidally effective amount of a bioherbicide composition as disclosed herein.

These and other aspects are disclosed in further detail below.

### BRIEF DESCRIPTION OF THE FIGURES

FIG. 1 is a diagram showing the Pseudomonas fluorescens strain D7 method of action;

FIG. 2 is a line graph showing the percent germination of Bromus tectorum in petri dish 1 at 8 days after planting of control seeds (untreated), seeds treated with Pseudomonas fluorescens strain D7, seeds treated with ethylene receptor blocker; and seeds treated with Pseudomonas fluorescens strain D7 and ethylene receptor blocker;

FIG. 3 is a line graph showing the percent germination of Bromus tectorum in petri dish 1 at 14 days after planting of control seeds (untreated), seeds treated with Pseudomonas fluorescens strain D7, seeds treated with ethylene receptor blocker; and seeds treated with Pseudomonas fluorescens strain D7 and ethylene receptor blocker;

FIG. 4 is a line graph showing the percent germination of Bromus tectorum in petri dish 2 at 8 days after planting control seeds (untreated), seeds treated with Pseudomonas fluorescens strain D7, seeds treated with ethylene receptor blocker; and seeds treated with Pseudomonas fluorescens strain D7 and ethylene receptor blocker; and

FIG. 5 is a line graph showing the percent germination of Bromus tectorum in petri dish 2 at 11 days after planting of control seeds (untreated), seeds treated with Pseudomonas fluorescens strain D7, seeds treated with ethylene receptor blocker; and seeds treated with Pseudomonas fluorescens strain D7 and ethylene receptor blocker.

### DETAILED DESCRIPTION

The present invention can be understood more readily by reference to the following detailed description of the invention and the examples included therein.

Before the present compounds, compositions, articles, systems, devices, and/or methods are disclosed and described, it is to be understood that they are not limited to specific synthetic methods unless otherwise specified, or to particular components unless otherwise specified, as such may, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

The present disclosure relates to compositions comprising a bacterial ethylene biosynthesis inhibitor and an ethylene receptor blocker in herbicidally effective amounts, and the use of such compositions that can be employed in agricultural applications, e.g., to control the growth of invasive weeds such as cheatgrass. More particularly, the ethylene biosynthesis inhibitor is a biological entity, while the ethylene receptor blocker is a chemical compound. For example, the bacterial ethylene biosynthesis inhibitor can be a bacterial Pseudomonas fluorescens strain, while the ethylene receptor blocker can be a chemical compound (e.g., a substituted cyclopropene derivative). In further embodiments, the bacterial Pseudomonas fluorescens strain and the ethylene receptor blocker are present in synergistically effective amounts.

Described herein is the surprising and unexpected effect that a bacterial Pseudomonas fluorescens strain (e.g., Pseudomonas fluorescens strain D7) and an ethylene receptor blocker (e.g., 1-methylcylopropene; 1-MCP) provide a reduction of germination in Bromus tectorum. The hypothesized mode of action is that: 1) Pseudomonas fluorescens strain D7 reduces the biosynthesis of ethylene within plants; and 2) 1-MCP blocks ethylene receptors, thereby preventing the biological activity of any ethylene present in the plant. Ethylene is an important component in various plant species to overcome seed dormancy and initiate seed germination. Thus, with a reduction in ethylene being present, overcoming seed dormancy becomes increasingly challenging and a reduction in seed germination therefore occurs. Thus, the link between sufficient ethylene being available and the extend of seed germination taking place is an important observation when it comes to the development of the bioherbicide compositions disclosed herein. For the bioherbicide compositions disclosed herein, the observed reduction of seed germination of invasive grass weeds (e.g., Cheatgrass) occurs in a synergistically effective manner. Accordingly, in some embodiments, the bioherbicide compositions disclosed herein permit control of invasive grass weeds, such as cheatgrass, without negatively affecting native plants or crops or changing the soil ecosystem.

In addition to playing a part in overcoming seed dormancy and initiating seed germination, ethylene has many other functions that affect plant growth and development, as well as effects on other plant hormones. The ability to control the timing of developmental events by manipulation of ethylene biosynthesis and biological activity of ethylene in crops has several potential advantages besides just control of invasive grass weeds. For example, the following applications are also possible using the compositions disclosed herein:
(a) delaying budbreak during late cold snaps in fruit and nut trees and fruiting vines;
(b) delaying post-harvest ripening and storage longevity in climacteric fruits that are strong producers of ethylene, such as banana, apple, pear, cantaloupe, avocado, and tomato;
(c) suppressing sprouting during post-harvest storage of tubers;
(d) delaying floral induction in some crops, such as pineapple and mango;
(e) inhibition of stem elongation in potted forced bulbs;
(f) preventing yellowing of leafy crops such as spinach, kale, lettuce, or herbs during the post-harvest period;
(g) delaying leaf senescence in woody nursery crops and cut flowers, or in broadacre crops during periods of stress;
(h) improving quality of specialty crops, e.g. reduction of bitterness in carrots, reduced toughness of asparagus and peapods, and reduction of bitter pit in post-harvest apples;
(i) reducing premature floral abscission in soybean, tomato, fruit trees, flowering ornamentals, and other crops due to biotic and abiotic environmental stresses (heat, pathogens, drought); and
(j) controlling general stress response in plants during cold, flooding, ozone exposure, and wounding.

While aspects of the present invention can be described and claimed in a particular statutory class, such as the system statutory class, this is for convenience only and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is in no way intended that an order be inferred in any respect. This holds for any possible non-express basis for interpretation, including matters of logic with respect to arrangement of steps or operational flow, plain meaning derived from grammatical organization or punctuation, or the number or type of aspects described in the specification.

### A. Definitions

Listed below are definitions of various terms used to describe this invention. These definitions apply to the terms as they are used throughout this specification, unless otherwise limited in specific instances, either individually or as part of a larger group.

As used herein, the term “alkyl group” refers to a saturated hydrocarbon radical containing 1 to 10, 1 to 6, 1 to 4, or 5 to 10 carbons. An alkyl group is structurally similar to a noncyclic alkane compound modified by the removal of one hydrogen from the noncyclic alkane and the substitution therefor of a non-hydrogen group or radical. Alkyl group radicals can be branched or unbranched. Lower alkyl group radicals have 1 to 4 carbon atoms. Higher alkyl group radicals have 5 to 10 carbon atoms. Examples of alkyl, lower alkyl, and higher alkyl group radicals include, but are not limited to, methyl, ethyl, n-propyl, iso-propyl, n-butyl, sec butyl, t butyl, amyl, t amyl, n-pentyl, n-hexyl, i-octyl and like radicals.

As used herein, the term “substituted” refers to a moiety (such as an alkyl group) wherein the moiety is bonded to one or more additional organic or inorganic substituent radicals. In some embodiments, the substituted moiety comprises 1, 2, 3, 4, or 5 additional substituent groups or radicals. Suitable organic and inorganic substituent radicals include, but are not limited to, hydroxyl, cycloalkyl, aryl, substituted aryl, heteroaryl, heterocyclic ring, substituted heterocyclic ring, amino, mono-substituted amino, di-substituted amino, acyloxy, nitro, cyano, carboxy, carboalkoxy, alkyl carboxamide, substituted alkyl carboxamide, dialkyl carboxamide, substituted dialkyl carboxamide, alkylsulfonyl, alkylsulfinyl, thioalkyl, alkoxy, substituted alkoxy or haloalkoxy radicals, wherein the terms are defined herein. Unless otherwise indicated herein, the organic substituents can comprise from 1 to 4 or from 5 to 8 carbon atoms. When a substituted moiety is bonded thereon with more than one substituent radical, then the substituent radicals may be the same or different.

As used herein, the term “unsubstituted” refers to a moiety (such as an alkyl group) that is not bonded to one or more additional organic or inorganic substituent radical as described above, meaning that such a moiety is only substituted with hydrogens.

As used herein, the term “alkoxy” refers to an alkyl radical bound through a single, terminal ether linkage; that is, an “alkoxy” group can be defined as —OR where R is alkyl as defined above. Examples include, but are not limited to, methoxy, ethoxy, n-propoxy, iso-propoxy, n-butoxy, t-butoxy, iso-butoxy and the like.

As used herein, the term “substituted alkoxy” refers to an alkoxy radical as defined above having one, two, or more additional organic or inorganic substituent radicals bound to the alkyl radical. Suitable organic and inorganic substituent radicals include, but are not limited to, hydroxyl, cycloalkyl, amino, mono-substituted amino, di-substituted amino, acyloxy, nitro, cyano, carboxy, carboalkoxy, alkyl carboxamide, substituted alkyl carboxamide, dialkyl carboxamide, substituted dialkyl carboxamide, alkylsulfonyl, alkylsulfinyl, thioalkyl, thiohaloalkyl, alkoxy, substituted alkoxy, or haloalkoxy. When the alkyl of the alkoxy is bonded thereon with more than one substituent radical, then the substituent radicals may be the same or different.

As used in the specification and the appended claims, the singular forms “a,” “an” and “the” include plural referents unless the context clearly dictates otherwise. Thus, for example, reference to “an abrasive” or “a pH adjusting agent” includes mixtures of two or more such abrasives or pH adjusting agents.

The term “synergistic effect” is understood to be defined according to Colby's formula (Colby, S. R., “Calculating synergistic and antagonistic responses of herbicide combinations,” Weeds, 15, pp. 20-22, 1967).

As used herein, the term “synergistically effective” refers to an effect that is obtained from two different chemicals (e.g., an ethylene receptor blocker and a strain of Pseudomonas fluorescens bacteria) that is greater than the sum of their individual effects at the same doses.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units is also disclosed. For example, if 10 and 15 are disclosed, then 11, 12, 13, and 14 are also disclosed.

References in the specification and concluding claims to parts by weight of a particular element or component in a composition denote the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compositions.

A weight percent (wt %) of a component, unless specifically stated to the contrary, is based on the total weight of the vehicle or composition in which the component is included.

As used herein, the term “effective amount” refers to an amount of a composition and/or the amount of each component in the composition (i.e., ethylene biosynthesis inhibitor and/or ethylene receptor blocker), which is sufficient for inhibiting seed germination of at least some of the invasive grass species (such as cheatgrass) that is exposed to the particular compound. For example, the effective amount may be an amount sufficient to inhibit seed germination of some of the cheatgrass that is present. In specific embodiments of the disclosure, an effective amount inhibits the seed germination of cheatgrass by at least 10%. In particular embodiments of the disclosure, an effective amount inhibits seed germination of cheatgrass by at least 20%, or even 50%. A skilled artisan is well aware of the fact that such an amount can vary in a broad range, and is dependent on various factors, e.g., weather, target species, locus, mode of application, soil type, treated cultivated plant or material, and the climatic conditions. Specific examples of effective amounts are provided in the examples below.

As used herein, the term “soil” is to be understood as a natural body comprised of living (e.g., microorganisms (such as bacteria and fungi), animals, and plants) and nonliving matter (e.g., minerals and organic matter (e.g., organic compounds in varying degrees of decomposition), liquid, and gases) that occurs on the land surface, and is characterized by soil horizons that are distinguishable from the initial material as a result of various physical, chemical, biological, and anthropogenic processes. From an agricultural point of view, soils are predominantly regarded as the anchor and primary nutrient base for plants (plant habitat).

As used herein, the term “fertilizer” is to be understood as chemical compounds applied to promote plant and fruit growth. Fertilizers are typically applied either through the soil (for uptake by plant roots) or by foliar feeding (for uptake through leaves). The term “fertilizer” can be subdivided into two major categories: a) organic fertilizers (composed of decayed plant/animal matter) and b) inorganic fertilizers (composed of chemicals and minerals). Organic fertilizers include manure, slurry, worm castings, peat, seaweed, sewage, and guano. Green manure crops are also regularly grown to add nutrients (especially nitrogen) to the soil. Manufactured organic fertilizers include compost, blood meal, bone meal, and seaweed extracts. Further examples are enzymatically digested proteins, fish meal, and feather meal. The decomposing crop residue from prior years is another source of fertility. In addition, naturally occurring minerals such as mine rock phosphate, sulfate of potash, and limestone are also considered inorganic fertilizers. Inorganic fertilizers are usually manufactured through chemical processes (such as the Haber-Bosch process), also using naturally occurring deposits, while chemically altering them (e.g., concentrated triple superphosphate). Naturally occurring inorganic fertilizers include Chilean sodium nitrate, mine rock phosphate, and limestone.

As used herein, the term “seed” comprises seeds of all types, such as, for example, corns, seeds, fruits, tubers, seedlings, and similar forms, but also for invasive grass weeds (i.e., cheatgrass).

As used herein, the term “control”, “controls”, or “controlling” as in, e.g., the phrase: “controls invasive grass weeds”, “controlling” invasive grass weeds, as used herein, refers to preventing spread or invasion, reducing the severity of already infested/invaded areas or suppression or eradication of the invasive grass weeds, e.g., cheatgrass, medusahead, Ventenata or other invasive weed grasses whose “control” is desired. Indeed, “controlling” as used herein refers to any indication of success in prevention, elimination, reduction or amelioration of an invasive grass weed population or an invasive grass weed problem. In exemplary embodiments, “control” of invasive grass weeds as disclosed herein, is brought about by inhibiting seed germination of the invasive grass weed(s). In other exemplary embodiments, “control” of invasive grass weeds as disclosed herein, is brought about by reducing the effects of invasive grass weed(s). In still other exemplary embodiments, “control” of invasive grass weeds as disclosed herein, is brought about by preventing further invasions of invasive grass weed(s).

Throughout this specification and the claims, the words “comprise,” “comprises,” and “comprising” are used in a nonexclusive sense, except where the context requires otherwise, and are synonymous with “including,” “containing,” or “characterized by,” meaning that it is open-ended and does not exclude additional, unrecited elements or method steps.

As used herein, the transitional phrase “consisting essentially of” limits the scope of a claim to the specified materials or steps “and those that do not materially affect the basic and novel characteristic(s)” of the claimed presently disclosed subject matter.

As used therein, the transitional phrase “consisting of” excludes any element, step, or ingredient not specified in the claim.

### B. Bioherbicide Compositions

The present disclosure relates to bioherbicide compositions comprising two components, an ethylene biosynthesis inhibitor and an ethylene receptor blocker, in herbicidally effective amounts that can be employed in agricultural applications. In some embodiments, the herbicidally effective amount is a synergistically effective amount. More particularly, the ethylene biosynthesis inhibitor is a biological entity, while the ethylene receptor blocker is a chemical compound. In some embodiments, the biological entity is a bacterium from the Pseudomonas fluorescens strain. In some embodiments, the ethylene receptor blocker is a chemical compound such as a substituted cyclopropene.

In the present disclosure, it was surprisingly found that the bacterial Pseudomonas fluorescens strain and the ethylene receptor blocker act synergistically to reduce seed germination in Bromus tectorum. The bacterial strain of Pseudomonas fluorescens is known to inhibit germination of certain plant species, including several invasive weed species. Compounds that block ethylene receptors, such as substituted cyclopropenes, can act in concert with the bacterial strain to more effectively reduce seed germination.

The amount of bacterial Pseudomonas fluorescens strain and ethylene receptor blocker in the disclosed bioherbicide composition can vary. In some embodiments, the amount of bacterial Pseudomonas fluorescens strain and ethylene receptor blocker are present in a weight ratio of from about 150:1 to about 1:1, from about 125:1 to about 1:1, from about 100:1 to about 1:1, from about 100:1 to about 5:1, from about 90:1 to about 1:1, from about 80:1 to about 1:1, from about 70:1 to about 1:1, from about 60:1 to about 1:1, from about 50:1 to about 1:1, from about 40:1 to about 1:1, from about 30:1 to about 1:1, from about 20:1 to about 1:1, from about 15:1 to about 1:1, from about 10:1 to about 1:1, from about 9:1 to about 1:1, from about 8:1 to about 1:1, from about 7:1 to about 1:1, from about 6:1 to about 1:1, from about 5:1 to about 1:1; from about 4:1 to about 1:1, or from about 3:1 to about 2:1 of bacterial Pseudomonas fluorescens strain to ethylene receptor blocker. In some embodiments, the amount of bacterial Pseudomonas fluorescens strain and ethylene receptor blocker are present in a weight ratio of from about 100:1 to about 2:1, from about 100:1 to about 3:1, from about 100:1 to about 4:1, from about 100:1 to about 5:1, from about 100:1 to about 6:1 from about 100:1 to about 7:1, from about 100:1 to about 8:1, or from about 100:1 to about 9:1 of bacterial Pseudomonas fluorescens strain to ethylene receptor blocker. In some embodiments, the amount of bacterial Pseudomonas fluorescens strain and ethylene receptor blocker are present in a weight ratio of about 150:1, about 125:1, about 100:1, about 95:1, about 90:1, about 80:1, about 75:1, about 70:1, about 60:1, about 50:1, about 40:1, about 30:1, about 20:1, about 15:1, about 12:1, about 10:1, about 9:1, about 8:1, about 7:1, about 6:1, about 5:1, about 4:1, about 3:1, about 2:1 or about 1:1 of bacterial Pseudomonas fluorescens strain to ethylene receptor blocker.

In some embodiments, the bacterial Pseudomonas fluorescens strain and ethylene receptor blocker are present in synergistically effective amounts. In some embodiments, the amount of Pseudomonas fluorescens strain is more than the amount of ethylene receptor blocker present in the bioherbicide composition. In some embodiments, the amount of Pseudomonas fluorescens strain and ethylene receptor blocker present in the composition is the same.

In some embodiments, the bioherbicide composition reduces the germination of invasive grass weeds by at least about 10%, about 20%, about 30%, about 40%, about 50%, or about 60%.

Without being bound by theory, it is believed that: 1) the bacterial Pseudomonas fluorescens strain partially reduces the biosynthesis of ethylene, and 2) the ethylene receptor blocker subsequently blocks receptors, thereby reducing the activity of any ethylene that was successfully produced. Such activities include, but are not limited to, overcoming seed dormancy and/or inhibiting seed germination.

The individual components of the disclosed bioherbicide composition will be described in more detail below.

### 1. Ethylene Biosynthesis Inhibitor

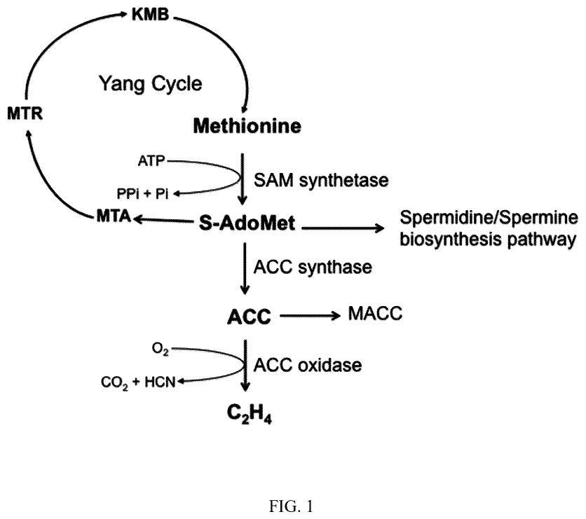

The bioherbicide composition disclosed herein contains an ethylene biosynthesis inhibitor. The biosynthetic synthesis of ethylene is shown in FIG. 1 and consists of two dedicated steps. In the first step, S-adenosyl-methione (SAM), generated from the Yang cycle, is converted into 1-aminocyclopropane-1-carboxylic acid (ACC) by ACC-synthase (ACS). In the second step, ACC is converted into ethylene by ACC-oxidase (ACO). In some embodiments, the ethylene biosynthesis inhibitor can inhibit the first step in the Yang cycle.

In some embodiments, the ethylene biosynthesis inhibitor disclosed herein is a biological entity, such as, but not limited to, a bacteria from the Pseudomonas fluorescens strain. The Pseudomonas fluorescens strain is a common non-pathogenic saprophyte that colonizes soil, water, and plant surfaces. It produces a soluble green fluorescent pigment. Pseudomonas fluorescens bacteria suppress plant diseases by protecting the seeds and roots from fungal infections. This bacterium is mass-produced using fermentation technology.

In some embodiments, the strain of Pseudomonas flourescens bacteria is selected from the group consisting of AD31 (NRRL #B-30483), AH4 (NRRL #B-30482), E34 (NRRL #B-30481), WH19 (NRRL #B-30484), AH10 (NRRL #B-50232), BT1 (NRRL #B-50230), E24 (NRRL #B-50229), TR33 (NRRL #B-50220), TR44 (NRRL #B-50219), TR46 (NRRL #B-50218), A3422A (NRRL #B-50234), ALW38 (NRRL #B-50231), G2Y (NRRL #B-50228), GTR12 (NRRL #B-50227), GTR24 (NRRL #B-50226), GTR40 (NRRL #B-50225), HB14 (NRRL #B-50224), HB26 (NRRL #B-50223), HB32 (NRRL #B-50222), ST22 (NRRL #B-50221), SMK69, D7, ACK55, NKK78, W36 (NRRL #B-50217), and combinations thereof.

In some embodiments, the ethylene biosynthesis inhibitor is a Pseudomonas fluorescens strain selected from D7 (NRRL #B-18293), NKK78 (NRRL #B-50849), SMK69 (NRRL #B-50850), ACK55 (NRRL #B-50848) and combinations thereof. These Pseudomonas fluorescens strains are naturally occurring rod-shaped bacteria that produce metabolites that are able to inhibit downy brome, medusahead and jointed goatgrass root cell elongation. In particular, these metabolites selectively inhibit the root cell elongation and tiller initiation of seeds. Because of its selectivity, these bacteria are useful for management of invasive grass weeds such as downy brome, medusahead and jointed goatgrass in rangeland, cropland, pasture, turf, sod production, golf courses, road sides and road cuts, construction sites, and right-of-ways (road, rail, pipeline, electrical) as will be described in more detail below. Typically, these bacteria grow well under cooler conditions of the fall coinciding with the early root growth of the fall annual weeds. Their numbers (and hence their activity) decline with summer temperatures, and by doing so, they do not overrun the native soil bacteria. These bacteria are not considered to be competitive bacteria, though they can survive at low number over a few years and can move in soil by traveling on the growing root or with water.

In some embodiments, the ethylene biosynthesis inhibitor is a commercially available bacterial Pseudomonas flourescens strain. For example, in some embodiment, the ethylene biosynthesis inhibitor is the bacterial Pseudomonas flourescens D7 strain. The bacterial Pseudomonas flourescens D7 strain is known to inhibit germination of certain plant species, including several invasive weed species. These bacteria produce certain metabolites, which interfere with the biosynthesis of ethylene during seed germination. Some plant species require endogenous production of ethylene, a gaseous plant hormone, to overcome dormancy in early stages of germination. In such species, interfering with either the biosynthesis of ethylene or the function of its receptors will interfere with successful seed germination. Although these bacteria interfere with the first step of ethylene biosynthesis, some ethylene production still occurs. The escaped ethylene may allow germination to proceed in the originating seed or in neighboring seeds as exogenous ethylene, however to a much lesser extend. This aligns with the general observations that effective weed suppression requires multiple years of bacterial Pseudomonas flourescens D7 strain application. Weed populations can be gradually eradicated as germination is continuously reduced by a certain percentage of seed each year.

The amount of bacterial Pseudomonas fluorescens strain present in the bioherbicide composition can vary. In some embodiments, the bacterial Pseudomonas fluorescens strain is present in an amount from about 0.1% to about 99.9% w/w, from about 1.0% to about 99.9% w/w, from about 5.0% to about 99.9% w/w, from about 10% to about 99.9% w/w, from about 20% to about 99.9% w/w, from about 30% to about 99.9%, from about 40% to about 99.9%, from about 50% to about %, from about 60% to about 99.9%, from about 70% to about 99.9%, from about 75% to about 99.9%, from about 80% to about 99.9%, from about 85% to about 99.9%, from about 90% to about 99.9%, from about 90% to about 95%, from about 85% to about 95%, or from about 88% to about 93% based on the total weight of the bioherbicide composition. In some embodiments, amount of bacterial Pseudomonas fluorescens strain present in the composition is at least about 50%, about 60%, about 70%, about 80%, about 85%, about 88%, about 90%, about 91%, about 92, about 93, about 94, about 95%, about 96%, about 97%, or at least about 98% based on the total weight of the composition.

### 2. Ethylene Receptor Blocker

The bioherbicide composition disclosed herein comprises, in addition to the ethylene biosynthesis inhibitor described above, an ethylene receptor blocker. Not to be bound theory, but it is believed that the ethylene biosynthesis inhibitor interferes with the production of ethylene. Small amounts of ethylene can still be produced, even in the presence of the above described ethylene biosynthesis inhibitor. This small amount of ethylene can modulate various processes in plants, such as seed dormancy and/or germination.

Ethylene (CH₂═CH₂) is a gaseous hormone regularly produced by plant cells which diffuses out of plant tissue. Plant cells produce low levels of ethylene at all times, and these levels affect normal growth and development. Depending upon the growth stage of the plant, various plant parts demonstrate specialized effects as a result of exposure to ethylene. For example, ethylene plays an important role in seed germination, specifically for overcoming dormancy (which can vary widely across plant species). Ethylene can also cause the premature aging of plant organs including, for example, flowers, leaves, fruits, and vegetables. Ethylene also promotes leaf yellowing, stunted growth, and premature fruit, flower, and leaf drop. In the case of fruits, vegetables, and other produce, ethylene effects the ripening process.

These physiological outcomes are achieved through a specific ethylene receptor in plants. Compounds other than ethylene are known to interact with this ethylene receptor. Some compounds mimic the action of ethylene while others prevent ethylene from binding, thereby counteracting the action of ethylene.

Methods of modulating the ethylene response in plants have been reported in various disclosures, such as U.S. Pat. Nos. 5,100,462 and 5,518,988, which are hereby incorporated by reference in their entireties. These patents disclose the use of chemical compounds such as diazocyclopentadiene, cyclopropenes, and derivatives of each as modulators of the ethylene response in plants.

In some embodiments, the ethylene receptor blocker disclosed herein is a compound of Formula (I):

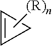

wherein n is an integer selected from 1, 2, 3 and 4; and
each R is independently selected from the group consisting of —H, —OH, —NH₂, halogen, substituted or unsubstituted (C1-C4) alkyl, substituted or unsubstituted (C1-C4) alkoxy, substituted or unsubstituted (C1-C4) carboxy, substituted or unsubstituted (C2-C6) alkenyl, substituted or unsubstituted phenyl, substituted or unsubstituted benzyl, and a combination thereof.

In some embodiments, n is 1.

In some embodiments, R is substituted or unsubstituted (C1-C4) alkyl. In some embodiments, R is unsubstituted (C1-C4) alkyl. In some embodiments, R is methyl.

In some embodiments, n is 1 and R is substituted or unsubstituted (C1-C4) alkyl. In some embodiments, n is 1 and R is unsubstituted (C1-C4) alkyl. In some embodiments, n is 1 and R is methyl.

In some embodiments, the ethylene receptor blocker is selected from the group consisting of cyclopropene, 1-methylcyclopropene, 3,3-dimethycyclopropene, methylenecyclopropane, diazocyclopentadiene, trans-cyclooctene, cis-cyclooctene, and 2,5-norbornadiene, and a combination thereof.

In some embodiments, the ethylene receptor blocker is 1-methylcyclopropane (1-MCP). 1-MCP can be used as a plant regulator to inhibit ethylene activity in cut flowers, potted flowers, bedding, nursery and foliage plants, and in stored fruits and vegetables. Two principal commercial uses of 1-MCP include maintaining the freshness of ornamental plants and flowers, and preventing the ripening of fruits. 1-MCP is used for prolonging the life of ornamental plants and cut flowers by preventing ethylene from attaching to plant receptors. In this use, it is a postharvest tool for counteracting undesirable effects of ethylene on harvested fruits and vegetables during transport and storage. 1-MCP is approved for use only in enclosed spaces, such as greenhouses, store rooms, coolers, enclosed truck trailers, controlled atmosphere food storage facilities, and shipping containers.

1-MCP is a gas under normal environmental conditions and is often combined with other materials for handling. The combination may then be mixed with a specific amount of water or other solution to release it into the air. As a small molecule gas, 1-MCP tends to dissipate quickly, which reduces its efficacy. Most recently, U.S. Pat. No. 6,017,849, which is hereby incorporated by reference in its entirety, encapsulates 1-MCP gas in a carrier, thereby providing a convenient and safe means of storing, transporting and applying or delivering the gas to plants. 1-MCP is effective at a very low dosages (e.g., dosages ranging from about 500 ppb to about 1 ppm) and is safe to be used in fruits and vegetables, as well as flowers.

As already mentioned above, while 1-MCP interacts with the same plant hormone pathway as the ethylene biosynthesis inhibitors disclosed herein (e.g., Pseudomonas flourescens z strain D7), its activity occurs after ethylene is already produced. More particularly, the D7 strain of Pseudomonas fluorescens is known to inhibit germination of certain plant species, including several invasive weed species. These bacteria produce certain metabolites, which interfere with the biosynthesis of ethylene during seed germination. Compounds that block ethylene receptors, such as 1-methylcyclopropane (1-MCP), can act in concert with these metabolites to more effectively prevent seed germination. It was therefore surprising and unexpected to observe a synergistic effect of this particular combination of an ethylene biosynthesis inhibitor and an ethylene receptor blocker on the seed germination and plant growth of various invasive grass weeds.

Thus, in some embodiments, the disclosed bioherbicide composition comprises an ethylene biosynthesis inhibitor as disclosed herein and an ethylene receptor blocker that prohibits binding of ethylene to its ethylene receptor. In some embodiments, the ethylene receptor blocker is selected from the group consisting of (2S,3E)-2-amino-4-(2-aminoethoxy)-3-butenoic acid, monohydrochloride (CAS Number: 55720-26-8) and silver thiosulfate (CAS 7761-88-8).

The amount of ethylene receptor blocker present in the bioherbicide composition can vary. In some embodiments, the ethylene receptor blocker is present in an amount from about 0.1% to about 99.9% w/w, from about 0.1% to about 90% w/w, from about 0.1% to about 80% w/w, from about 0.1% to about 70% w/w, from about 0.1% to about 60% w/w, from about 0.1% to about 50.0%, from about 0.1% to about 40.0%, from about 0.1% to about 30%, from about 0.1% to about 20.0%, from about 0.1% to about 15%, from about 1% to about 12%, from about 1% to about 10%, from about 1% to about 8%, from about 1% to about 5%, from about 1% to about 3%, from about 5% to about 15%, or from about 8% to about 12% based on the total weight of the bioherbicide composition. In some embodiments, amount of ethylene receptor blocker is present in the composition is less than about 20%, about 15%, about 12%, about 11%, about 10%, about 9%, about 8%, about 7%, about 6%, about 5%, about 4%, about 3%, about 2%, about 1%, or at least about 0.5% based on the total weight of the composition.

### 3. Carriers and Fillers

The compositions described herein can include carriers. A carrier is a natural or synthetic, organic or inorganic substance for admixing or combining with the compositions for better applicability, in particular for application to plants or plant parts. The carrier, which may be solid or liquid, is generally inert and should be suitable for use in agriculture. Useful solid or liquid carriers include, for example, ammonium salts and natural rock dusts, such as kaolins, clays, talc, chalk, quartz, attapulgite, montmorillonite or diatomaceous earth, and synthetic rock dusts, such as finely divided silica, alumina and natural or synthetic silicates, resins, waxes, solid fertilizers, water, alcohols, especially butanol, organic solvents, mineral and vegetable oils, and derivatives thereof. Additional solid carriers include, for example, crushed and fractionated natural rocks such as calcite, marble, pumice, sepiolite, dolomite, and synthetic granules of inorganic and organic meals, and also granules of organic material such as sawdust, coconut shells, maize cobs and tobacco stalks. Mixtures of such carriers can likewise be used.

Suitable solid fillers include inorganic particles, e.g., carbonates, silicates, sulphates and oxides with an average particle size of between 0.005 and 20 μm, preferably of between 0.02 to 10 μm, for example, ammonium sulphate, ammonium phosphate, urea, calcium carbonate, calcium sulphate, magnesium sulphate, magnesium oxide, aluminum oxide, silicium dioxide, so-called fine-particle silica, silica gels, natural or synthetic silicates, and aluminosilicates and plant products like cereal flour, wood powder/sawdust and cellulose powder.

### 4. Bioherbicide Formulation

The disclosed bioherbicide composition can be used in an unmodified original form (e.g., neat) or can be formulated into a bioherbicide formulation comprising one or more auxiliaries selected from extenders, carriers, solvents, surfactants (surface-active agents), stabilizers, anti-foaming agents, anti-freezing agents, preservatives, antioxidants, viscosity modifiers, suspending agents, light absorbers, corrosion inhibitors, fragrances, pH-modifying substances, glidants, lubricants, plasticisers, complexing agents, colorants, thickeners, solid adherents, fillers, wetting agents, dispersing agents, lubricants, anticaking agents, deformers and diluents. Such auxiliaries are known in the art and are commercially available. Their use in the formulation of the disclosed bioherbicide compositions will be apparent to a person skilled in the art.

The amount of bioherbicide composition present in the bioherbicide formulation as disclosed herein can vary. In some embodiments, the bioherbicide composition is present in an amount ranging from about 0.1% to about 99.9%, from about 10% to about 90%, from about 20% to about 80%, from about 30% to about 70%, or from about 40% to about 60% by weight based on the total weight of the bioherbicide formulation. In some embodiments, the bioherbicide composition is present in an amount ranging from about 0.1% to about 75%, from about 1% to about 70% from about 10% to about 60%, from about 20% to about 50%, or from about 25% to about 40% by weight based on the total weight of the bioherbicide formulation. In some embodiments, the bioherbicide composition is present in an amount ranging from about 10% to about 99.9%, from about 20% to about 95%, from about 30% to about 90% from about 35% to about 80% from about 40% to about 75%, or from about 50% to about 70% by weight based on the total weight of the bioherbicide formulation.

In some embodiments, the bioherbicide formulation contains one or more auxiliaries selected from carriers and/or solvents. Exemplary carriers and/or solvent that can be used in liquid bioherbicide formulations include, but are not limited to, water, toluene, xylene, petroleum ether, vegetable oils, acetone, methyl ethyl ketone, cyclohexanone, acid anhydrides, acetonitrile, acetophenone, amyl acetate, 2-butanone, butylene carbonate, chlorobenzene, cyclohexane, cyclohexanol, alkyl esters of acetic acid, diacetone alcohol, 1,2-dichloropropane, diethanolamine, p-diethylbenzene, diethylene glycol, diethylene glycol abietate, diethylene glycol butyl ether, diethylene glycol ethyl ether, diethylene glycol methyl ether, N,N-dimethylformamide, dimethyl sulfoxide, 1,4-dioxane, dipropylene glycol, dipropylene glycol methyl ether, dipropylene glycol dibenzoate, diproxitol, alkylpyrrolidone, ethyl acetate, 2-ethylhexanol, ethylene carbonate, 1,1,1-trichloroethane, 2-heptanone, alpha-pinene, d-limonene, ethyl lactate, ethylene glycol, ethylene glycol butyl ether, ethylene glycol methyl ether, gamma-butyrolactone, glycerol, glycerol acetate, glycerol diacetate, glycerol triacetate, hexadecane, hexylene glycol, isoamyl acetate, isobornyl acetate, isooctane, isophorone, isopropylbenzene, isopropyl myristate, lactic acid, laurylamine, mesityl oxide, methoxypropanol, methyl isoamyl ketone, methyl isobutyl ketone, methyl laurate, methyl octanoate, methyl oleate, methylene chloride, m-xylene, n-hexane, n-octylamine, octadecanoic acid, octylamine acetate, oleic acid, oleylamine, o-xylene, phenol, polyethylene glycol, propionic acid, propyl lactate, propylene carbonate, propylene glycol, propylene glycol methyl ether, p-xylene, toluene, triethyl phosphate, triethylene glycol, xylenesulfonic acid, paraffin, mineral oil, trichloroethylene, perchloroethylene, ethyl acetate, amyl acetate, butyl acetate, propylene glycol methyl ether, diethylene glycol methyl ether, methanol, ethanol, isopropanol, and alcohols of higher molecular weight, such as amyl alcohol, tetrahydrofurfuryl alcohol, hexanol, octanol, ethylene glycol, propylene glycol, glycerol, A/-methyl-2-pyrrolidone and the like.

In some embodiments, the carrier medium, or vehicle, is water. Ion exchanged water (deionized water), pure water, ultrapure water, distilled water and the like may be used as the water. In order to reduce the amount of unwanted components present in the water, the purity of water may be increased by operations such as removal of impurity ions with an ion exchange resin, removal of contaminants with a filter, and/or distillation.

The amount of the liquid carrier(s) and/or solvent(s) present in a liquid bioherbicide formulation can vary. In some embodiments, the liquid carrier(s) and/or solvent(s) are present in an amount ranging from about 0.1% to about 99.9%, from about 10% to about 90%, from about 20% to about 80%, from about 30% to about 70%, or from about 40% to about 60% by weight based on the total weight of the liquid bioherbicide formulation. In some embodiments, the carrier(s) and/or solvent(s) are present in an amount ranging from about 0.1% to about 75%, from about 1% to about 70% from about 10% to about 60%, from about 20% to about 50%, or from about 25% to about 40% by weight based on the total weight of the bioherbicide formulation. In some embodiments, the carrier(s) and/or solvent(s) are present in an amount ranging from about 10% to about 99.9%, from about 20% to about 95%, from about 30% to about 90% from about 35% to about 80% from about 40% to about 75%, or from about 50% to about 70% by weight based on the total weight of the bioherbicide formulation.

In some embodiments, the bioherbicide formulation contains one or more auxiliaries selected from carriers that are used in solid bioherbicide formulations. Exemplary solid carriers include, but are not limited to, talc, titanium dioxide, pyrophyllite clay, silica, attapulgite clay, kieselguhr, limestone, calcium carbonate, bentonite, calcium montmorillonite, cottonseed husks, wheat flour, soybean flour, pumice, wood flour, ground walnut shells, lignin and similar substances.

The amount of the solid carrier(s) present in a solid bioherbicide formulation can vary. In some embodiments, the solid carrier(s) are present in an amount ranging from about 0.1% to about 99.9%, from about 10% to about 90%, from about 20% to about 80%, from about 30% to about 70%, or from about 40% to about 60% by weight based on the total weight of the solid bioherbicide formulation. In some embodiments, the solid carrier(s) are present in an amount ranging from about 0.1% to about 75%, from about 1% to about 70% from about 10% to about 60%, from about 20% to about 50%, or from about 25% to about 40% by weight based on the total weight of the bioherbicide formulation. In some embodiments, the solid carrier(s) are present in an amount ranging from about 10% to about 99.9%, from about 20% to about 95%, from about 30% to about 90% from about 35% to about 80% from about 40% to about 75%, or from about 50% to about 70% by weight based on the total weight of the bioherbicide formulation.

Further, a skilled person in the art would also be aware of the type and combination of auxiliaries that would be required to optimize the bioherbicide formulation based on properties apparent to a skilled person in the art.

The bioherbicide formulation can be in the form of a liquid or a solid. Examples of liquid and solid bioherbicide formulations include, but are not limited to, soluble liquids (SF), emulsifiable concentrates (EC), wettable powders (WP), dry flowable (DF), flowables (F), water soluble powders (SP), ultra-low-volume concentrate (ULV), suspension concentrates (SC), aqueous suspensions (AS), microencapsulated suspension (ME or MT), capsule suspension (CS), granules (G), or pellets (P). In some embodiments, the bioherbicide composition is in the form of a soluble salt, which is water soluble and requires little to no agitation to stay in solution. These types of formulations are often referred to as solutions (S), soluble concentrates (SC), liquid (L), and water soluble concentrates (WSC). In some embodiments, these types of formulations (e.g., S) are “ready-to-use”. In some embodiments, the formulation is a tank mix formulation or a premix formulation. In some embodiments, these types of formulations (e.g., SC or WSC) are diluted with water prior to use. In some embodiments, the herbicidal composition disclosed herein is in the form of a granule (G).

The bioherbicide formulation described herein may further contain additional components. The additional components may comprise, for example, protective colloids, binders, extenders, adhesives, tackifiers, thickeners, thixotropic substances, penetrants, stabilizers, sequestrants, surfactants, complexing agents, etc. In general, the compositions can be combined with any solid or liquid additive commonly used for formulation purposes. Additionally or alternatively, the compositions disclosed herein can include other additives as will be understood by those skilled in the art.

In the bioherbicide formulations, it is possible to use tackifiers such as carboxymethylcellulose, and natural and synthetic polymers in the form of powders, granules or lattices, such as gum arabic, polyvinyl alcohol and polyvinyl acetate, or else natural phospholipids, such as cephalins and lecithins, and synthetic phospholipids. Further additives may be mineral and vegetable oils. If the carrier used is water, it is also possible to employ, for example, organic solvents as auxiliary solvents.

The bioherbicide formulations may additionally comprise surfactants. Useful surfactants are emulsifiers and/or foam formers, dispersants or wetting agents having ionic or nonionic properties, or mixtures of these surfactants. Non-limiting examples of these are salts of polyacrylic acid, salts of lignosulphonic acid, salts of phenolsulphonic acid or naphthalenesulphonic acid, polycondensates of ethylene oxide with fatty alcohols or with fatty acids or with fatty amines, substituted phenols (preferably alkylphenols or arylphenols), salts of sulphosuccinic esters, taurine derivatives (preferably alkyl taurates), phosphoric esters of polyethoxylated alcohols or phenols, fatty esters of polyols, and derivatives of the compounds containing sulphates, sulphonates and phosphates, for example, alkylaryl polyglycol ethers, alkylsulphonates, alkylsulphates, arylsulphonates, protein hydrolysates, lignosulphite waste liquors and methylcellulose. The presence of a surfactant may be particularly preferred if one of the active ingredients and/or one of the inert carriers is insoluble in water and when application is affected in water. The proportion of surfactants is between about 5% and about 40% by weight of the composition. In some embodiments, the proportion of surfactants is between about 10% and about 30% or between about 15% and about 25% by weight of the composition. In some embodiments, the proportion of surfactance is between about 0.001% and about 20%, between about 0.001% to about 10%, between about 0.001% to about 8%, between about 0.001% to about 5%, between about 0.001% to about 3%, between about 0.01% to about 2%, between about 0.01% to about 1%, between about 0.01% to about 0.5%, between about 0.1% to about 0.25%, between about 0.01% to about 8%, between 0.01% to about 5%, between 0.1% to about 5%, between 0.1% to about 2.5%, between 1% to about 10%, between 1% to about 8%, between 1% to about 5%, or between about 1% to about 2.5% by weight based on the total weight of the composition. In some embodiments, the proportion of surfactant is less than about 40%, less than about 30%, less than about 25%, less than about 20%, less than about 10%, less than about 9%, less than about 8%, less than about 7%, less than about 6%, less than about 5%, less than about 4%, less than about 3%, less than about 2%, less than about 1%, less than about 0.5%, or less than about 0.001% by weight based on the total weight of the composition.

The bioherbicide formulations may further comprise colorants and dyes. Dyes include inorganic pigments, for example, iron oxide, titanium oxide and Prussian blue, and organic dyes such as alizarin dyes, azo dyes, metal phthalocyanine dyes, and trace nutrients such as salts of iron, manganese, boron, copper, cobalt, molybdenum, and zinc.

The bioherbicide formulations may further comprise antifoams, which may be present in the formulations include, e.g., silicone emulsions, long-chain alcohols, fatty acids and their salts as well as fluoroorganic substances and mixtures thereof.

The bioherbicide formulations may further comprise thickeners, such as include polysaccharides, e.g., xanthan gum or veegum, silicates, e.g., attapulgite, bentonite and fine-particle silica.

The bioherbicide formulations may further comprise a carrier medium, or vehicle, wherein that medium or vehicle is water. Ion exchanged water (deionized water), pure water, ultrapure water, distilled water and the like may be used as the water. In order to reduce the amount of unwanted components present in the water, the purity of water may be increased by operations such as removal of impurity ions with an ion exchange resin, removal of contaminants with a filter, and/or distillation.

### 5. Agricultural Composition(s)

Any of the described bioherbicide compositions can be further combined with one or more other ingredients, selected from the group consisting of fertilizer, seed, agriculturally active compounds, pesticides, herbicide, and the like to afford agricultural compositions. In some embodiments, the bioherbicide composition may be mixed with the one or more other ingredients; and/or applied as a surface coating to the one or more other ingredients, impregnated onto the one or more other ingredients, absorbed onto the one or more ingredients, or otherwise thoroughly mixed with the one or more other ingredients. A skilled person in the art would be aware of what type of other ingredient(s) would be compatible with the bioherbicide composition described herein.

For example, in some embodiments, the bioherbicide compositions disclosed herein can be combined with a fertilizer. The fertilizer can be a solid fertilizer, such as, but not limited to, a granular fertilizer, and the bioherbicide composition can be applied to the fertilizer as a liquid dispersion. The fertilizer can be in liquid form, and the bioherbicide composition can be mixed with the liquid fertilizer. The fertilizers can be selected from the group consisting of starter fertilizers, phosphate-based fertilizers, fertilizers containing nitrogen, fertilizers containing potassium, fertilizers containing calcium, fertilizers containing magnesium, fertilizers containing boron, fertilizers containing chlorine, fertilizers containing zinc, fertilizers containing manganese, fertilizers containing copper, fertilizers containing urea and ammonium nitrite and/or fertilizers containing molybdenum, iron and/or sulfur-containing materials. In some embodiments, the fertilizer is an NPK fertilizer containing nitrogen, phosphorus and potassium (e.g., NPK 6-24-6 and/or NPK 15-5-15). In some embodiments, the fertilizer is or contains urea, and/or ammonia, including anhydrous ammonia fertilizer. In some embodiments, the fertilizer comprises plant-available nitrogen, phosphorous, potassium, sulfur, calcium, magnesium or micronutrients. In some embodiments, the fertilizer is solid, granular, a fluid suspension, a gas, or a solutionized fertilizer. In some embodiments, the fertilizer comprises a micronutrient. A micronutrient is an essential element required by a plant in small quantities. In some embodiments, the fertilizer comprises a metal ion selected from the group consisting of: Fe, Mn, Mg, Zn, Cu, Ni, V, Mo, and Ca. In some embodiments, the fertilizer comprises gypsum, kieserite group member, potassium product, potassium magnesium sulfate, elemental sulfur, or potassium magnesium sulfate. Such fertilizers may be granular, liquid, gaseous, or mixtures (e.g., suspensions of solid fertilizer particles in liquid material). In some embodiments, the bioherbicide composition is combined with any suitable liquid or dry fertilizer for application to fields and/or crops. The described bioherbicide composition, or formulations thereof, can be applied with the application of a fertilizer. The bioherbicide composition can be applied prior to, subsequent to, or simultaneously with the application of fertilizers.

In some embodiments, the bioherbicide composition disclosed herein is combined with seeds of wanted vegetation. For example, in some embodiments, seeds of wanted vegetation are coated with the bioherbicide composition disclosed herein to render agricultural seed compositions. The bioherbicide composition can be present in the agricultural seed composition at a level of from about 0.001% to about 10%, about 0.004% to about 2%, about 0.01% to about 1%, or from about 0.1% to about 1% by weight (or no more than about 10%, about 9%, about 8%, about 7% about 6%, about 5%, about 4%, about 3%, about 2%, about 1%, about 0.5%, about 0.1%, about 0.01% or no more than 0.001%), based upon the total weight of the coated seed product.

In some embodiments, the bioherbicide composition further comprises a pesticide component. In some embodiments, the pesticide component is selected from insecticides, bactericides, fungicides, larvicides, acaricides, nematocide, molluscicide, miticides, plant growth regulator, and a combination thereof. In some embodiments, the pesticide component is an insecticide. Exemplary insecticides include, but are not limited to, 1,2-dichloropropane, 1,3-dichloropropene, abamectin, acephate, acequinocyl, acetamiprid, acethion, acetoprole, acrinathrin, acrylonitrile, alanycarb, aldicarb, aldoxycarb, aldrin, allethrin, allosamidin, allyxycarb, alpha cypermethrin, alpha ecdysone, amidithion, amidoflumet, aminocarb, amiton, amitraz, anabasine, arsenous oxide, athidathion, azadirachtin, azamethiphos, azinphos-ethyl, azinphos-methyl, azobenzene, azocyclotin, azothoate, barium hexafluorosilicate, barthrin, benclothiaz, bendiocarb, benfuracarb, benoxafos, bensultap, benzoximate, benzyl benzoate, beta cyfluthrin, beta cypermethrin, bifenazate, bifenthrin, binapacryl, bioallethrin, bioethanomethrin, biopermethrin, bistrifluron, borax, boric acid, bromfenvinfos, bromo DDT, bromocyclen, bromophos, bromophos-ethyl, bromopropylate, bufencarb, buprofezin, butacarb, butathiofos, butocarboxim, butonate, butoxycarboxim, cadusafos, calcium arsenate, calcium polysulfide, camphechlor, carbanolate, carbaryl, carbofuran, carbon disulfide, carbon tetrachloride, carbophenothion, carbosulfan, cartap, chinomethionat, chlorantraniliprole, chlorbenside, chlorbicyclen, chlordane, chlordecone, chlordimeform, chlorethoxyfos, chlorfenapyr, chlorfenethol, chlorfenson, chlorfensulphide, chlorfenvinphos, chlorfluazuron, chlormephos, chlorobenzilate, chloroform, chloromebuform, chloromethiuron, chloropicrin, chloropropylate, chlorphoxim, chlorprazophos, chlorpyrifos, chlorpyrifos-methyl, chlorthiophos, chromafenozide, cinerin I, cinerin II, cismethrin, cloethocarb, clofentezine, closantel, clothianidin, copper acetoarsenite, copper arsenate, copper naphthenate, copper oleate, coumaphos, coumithoate, crotamiton, crotoxyphos, cruentaren A & B, crufomate, cryolite, cyanofenphos, cyanophos, cyanthoate, cyclethrin, cycloprothrin, cyenopyrafen, cyflumetofen, cyfluthrin, cyhalothrin, cyhexatin, cypermethrin, cyphenothrin, cyromazine, cythioate, d-limonene, dazomet, DBCP, DCIP, DDT, decarbofuran, deltamethrin, demephion, demephion O, demephion S, demeton, demeton methyl, demeton O, demeton O methyl, demeton S, demeton S methyl, demeton S methylsulphon, diafenthiuron, dialifos, diamidafos, diazinon, dicapthon, dichlofenthion, dichlofluanid, dichlorvos, dicofol, dicresyl, dicrotophos, dicyclanil, dieldrin, dienochlor, diflovidazin, diflubenzuron, dilor, dimefluthrin, dimefox, dimetan, dimethoate, dimethrin, dimethylvinphos, dimetilan, dinex, dinobuton, dinocap, dinocap 4, dinocap 6, dinocton, dinopenton, dinoprop, dinosam, dinosulfon, dinotefuran, dinoterbon, diofenolan, dioxabenzofos, dioxacarb, dioxathion, diphenyl sulfone, disulfiram, disulfoton, dithicrofos, DNOC, dofenapyn, doramectin, ecdysterone, emamectin, EMPC, empenthrin, endosulfan, endothion, endrin, EPN, epofenonane, eprinomectin, esfenvalerate, etaphos, ethiofencarb, ethion, ethiprole, ethoate-methyl, ethoprophos, ethyl DDD, ethyl formate, ethylene dibromide, ethylene dichloride, ethylene oxide, etofenprox, etoxazole, etrimfos, EXD, famphur, fenamiphos, fenazaflor, fenazaquin, fenbutatin oxide, fenchlorphos, fenethacarb, fenfluthrin, fenitrothion, fenobucarb, fenothiocarb, fenoxacrim, fenoxycarb, fenpirithrin, fenpropathrin, fenpyroximate, fenson, fensulfothion, fenthion, fenthion-ethyl, fentrifanil, fenvalerate, fipronil, flonicamid, fluacrypyrim, fluazuron, flubendiamide, flubenzimine, flucofuron, flucycloxuron, flucythrinate, fluenetil, flufenerim, flufenoxuron, flufenprox, flumethrin, fluorbenside, fluvalinate, fonofos, formetanate, formothion, formparanate, fosmethilan, fospirate, fosthiazate, fosthietan, fosthietan, furathiocarb, furethrin, furfural, gamma cyhalothrin, gamma HCH, halfenprox, halofenozide, HCH, HEOD, heptachlor, heptenophos, heterophos, hexaflumuron, hexythiazox, HHDN, hydramethylnon, hydrogen cyanide, hydroprene, hyquincarb, imicyafos, imidacloprid, imiprothrin, indoxacarb, iodomethane, IPSP, isamidofos, isazofos, isobenzan, isocarbophos, isodrin, isofenphos, isoprocarb, isoprothiolane, isothioate, isoxathion, ivermectin jasmolin I, jasmolin II, jodfenphos, juvenile hormone I, juvenile hormone II, juvenile hormone III, kelevan, kinoprene, lambda cyhalothrin, lead arsenate, lepimectin, leptophos, lindane, lirimfos, lufenuron, lythidathion, malathion, malonoben, mazidox, mecarbam, mecarphon, menazon, mephosfolan, mercurous chloride, mesulfen, mesulfenfos, metaflumizone, metam, methacrifos, methamidophos, methidathion, methiocarb, methocrotophos, methomyl, methoprene, methoxychlor, methoxyfenozide, methyl bromide, methyl isothiocyanate, methylchloroform, methylene chloride, metofluthrin, metolcarb, metoxadiazone, mevinphos, mexacarbate, milbemectin, milbemycin oxime, mipafox, mirex, MNAF, monocrotophos, morphothion, moxidectin, naftalofos, naled, naphthalene, nicotine, nifluridide, nikkomycins, nitenpyram, nithiazine, nitrilacarb, novaluron, noviflumuron, omethoate, oxamyl, oxydemeton-methyl, oxydeprofos, oxydisulfoton, paradichlorobenzene, parathion, parathion-methyl, penfluron, pentachlorophenol, permethrin, phenkapton, phenothrin, phenthoate, phorate, phosalone, phosfolan, phosmet, phosnichlor, phosphamidon, phosphine, phosphocarb, phoxim, phoxim-methyl, pirimetaphos, pirimicarb, pirimiphos-ethyl, pirimiphos-methyl, potassium arsenite, potassium thiocyanate, pp′ DDT, prallethrin, precocene I, precocene IL, precocene III, primidophos, proclonol, profenofos, profluthrin, promacyl, promecarb, propaphos, propargite, propetamphos, propoxur, prothidathion, prothiofos, prothoate, protrifenbute, pyraclofos, pyrafluprole, pyrazophos, pyresmethrin, pyrethrin I, pyrethrin II, pyridaben, pyridalyl, pyridaphenthion, pyrifluquinazon, pyrimidifen, pyrimitate, pyriprole, pyriproxyfen, quassia, quinalphos, quinalphos, quinalphos-methyl, quinothion, quantifies, rafoxanide, resmethrin, rotenone, ryania, sabadilla, schradan, selamectin, silafluofen, sodium arsenite, sodium fluoride, sodium hexafluorosilicate, sodium thiocyanate, sophamide, spinetoram, spinosad, spirodiclofen, spiromesifen, spirotetramat, sulcofuron, sulfiram, sulfluramid, sulfotep, sulfur, sulfuryl fluoride, sulprofos, tau fluvalinate, tazimcarb, TDE, tebufenozide, tebufenpyrad, tebupirimfos, teflubenzuron, tefluthrin, temephos, TEPP, terallethrin, terbufos, tetrachloroethane, tetrachlorvinphos, tetradifon, tetramethrin, tetranactin, tetrasul, theta cypermethrin, thiacloprid, thiamethoxam, thicrofos, thiocarboxime, thiocyclam, thiodicarb, thiofanox, thiometon, thionazin, thioquinox, thiosultap, thuringiensin, tolfenpyrad, tralomethrin, transfluthrin, transpermethrin, triarathene, triazamate, triazophos, trichlorfon, trichlormetaphos 3, trichloronat, trifenofos, triflumuron, trimethacarb, triprene, vamidothion, vamidothion, vaniliprole, vaniliprole, XMC, xylylcarb, zeta cypermethrin and zolaprofos.

In some embodiments, the pesticide component is a fungicide. Exemplary fungicides include, but are not limited to, acibenzolar, acylamino acid fungicides, acypetacs, aldimorph, aliphatic nitrogen fungicides, allyl alcohol, amide fungicides, ampropylfos, anilazine, anilide fungicides, antibiotic fungicides, aromatic fungicides, aureofungin, azaconazole, azithiram, azoxystrobin, barium polysulfide, benalaxyl, benalaxyl-M, benodanil, benomyl, benquinox, bentaluron, benthiavalicarb, benzalkonium chloride, benzamacril, benzamide fungicides, benzamorf, benzanilide fungicides, benzimidazole fungicides, benzimidazole precursor fungicides, benzimidazolylcarbamate fungicides, benzohydroxamic acid, benzothiazole fungicides, bethoxazin, binapacryl, biphenyl, bitertanol, bithionol, bixafen, blasticidin-S, Bordeaux mixture, boric acid, boscalid, bridged diphenyl fungicides, bromuconazole, bupirimate, Burgundy mixture, buthiobate, sec-butylamine, calcium polysulfide, captafol, captan, carbamate fungicides, carbamorph, carbanilate fungicides, carbendazim, carboxin, carpropamid, carvone, Cheshunt mixture, chinomethionat, chlobenthiazone, chloraniformethan, chloranil, chlorfenazole, chlorodinitronaphthalene, chloroform, chloroneb, chloropicrin, chlorothalonil, chlorquinox, chlozolinate, ciclopirox, climbazole, clotrimazole, conazole fungicides, conazole fungicides (imidazoles), conazole fungicides (triazoles), copper(II) acetate, copper(II) carbonate, basic, copper fungicides, copper hydroxide, copper naphthenate, copper oleate, copper oxychloride, copper(II) sulfate, copper sulfate, basic, copper zinc chromate, cresol, cufraneb, cuprobam, cuprous oxide, cyazofamid, cyclafuramid, cyclic dithiocarbamate fungicides, cycloheximide, cyflufenamid, cymoxanil, cypendazole, cyproconazole, cyprodinil, dazomet, DBCP, debacarb, decafentin, dehydroacetic acid, dicarboximide fungicides, dichlofluanid, dichlone, dichlorophen, dichlorophenyl, dichlozoline, diclobutrazol, diclocymet, diclomezine, dicloran, diethofencarb, diethyl pyrocarbonate, difenoconazole, diflumetorim, dimethirimol, dimethomorph, dimoxystrobin, diniconazole, diniconazole-M, dinitrophenol fungicides, dinobuton, dinocap, dinocap-4, dinocap-6, dinocton, dinopenton, dinosulfon, dinoterbon, diphenylamine, dipyrithione, disulfiram, ditalimfos, dithianon, dithiocarbamate fungicides, DNOC, dodemorph, dodicin, dodine, donatodine, drazoxolon, edifenphos, epoxiconazole, etaconazole, etem, ethaboxam, ethirimol, ethoxyquin, ethylene oxide, ethylmercury 2,3-dihydroxypropyl mercaptide, ethylmercury acetate, ethylmercury bromide, ethylmercury chloride, ethylmercury phosphate, etridiazole, famoxadone, fenamidone, fenaminosulf, fenapanil, fenarimol, fenbuconazole, fenfuram, fenhexamid, fenitropan, fenoxanil, fenpiclonil, fenpropidin, fenpropimorph, fentin, ferbam, ferimzone, fluazinam, fluconazole, fludioxonil, flumetover, flumorph, fluopicolide, fluoroimide, fluotrimazole, fluoxastrobin, fluquinconazole, flusilazole, flusulfamide, flutolanil, flutriafol, fluxapyroxad, folpet, formaldehyde, fosetyl, fuberidazole, furalaxyl, furametpyr, furamide fungicides, furanilide fungicides, furcarbanil, furconazole, furconazole-cis, furfural, furmecyclox, furophanate, glyodin, griseofulvin, guazatine, halacrinate, hexachlorobenzene, hexachlorobutadiene, hexachlorophene, hexaconazole, hexylthiofos, hydrargaphen, hymexazol, imazalil, imibenconazole, imidazole fungicides, iminoctadine, inorganic fungicides, inorganic mercury fungicides, iodomethane, ipconazole, iprobenfos, iprodione, iprovalicarb, isopropyl alcohol, isoprothiolane, isovaledione, isopyrazam, kasugamycin, ketoconazole, kresoxim-methyl, Lime sulfur (lime sulphur), mancopper, mancozeb, maneb, mebenil, mecarbinzid, mepanipyrim, mepronil, mercuric chloride (obsolete), mercuric oxide (obsolete), mercurous chloride (obsolete), metalaxyl, metalaxyl-M (a.k.a. Mefenoxam), metam, metazoxolon, metconazole, methasulfocarb, methfuroxam, methyl bromide, methyl isothiocyanate, methylmercury benzoate, methylmercury dicyandiamide, methylmercury pentachlorophenoxide, metiram, metominostrobin, metrafenone, metsulfovax, milneb, morpholine fungicides, myclobutanil, myclozolin, N-(ethylmercury)-p-toluenesulfonanilide, nabam, natamycin, nystatin, β-nitrostyrene, nitrothal-isopropyl, nuarimol, OCH, octhilinone, ofurace, oprodione, organomercury fungicides, organophosphorus fungicides, organotin fungicides (obsolete), orthophenyl phenol, orysastrobin, oxadixyl, oxathiin fungicides, oxazole fungicides, oxine copper, oxpoconazole, oxycarboxin, pefurazoate, penconazole, pencycuron, pentachlorophenol, penthiopyrad, phenylmercuriurea, phenylmercury acetate, phenylmercury chloride, phenylmercury derivative of pyrocatechol, phenylmercury nitrate, phenylmercury salicylate, phenylsulfamide fungicides, phosdiphen, phosphite, phthalide, phthalimide fungicides, picoxystrobin, piperalin, polycarbamate, polymeric dithiocarbamate fungicides, polyoxins, polyoxorim, polysulfide fungicides, potassium azide, potassium polysulfide, potassium thiocyanate, probenazole, prochloraz, procymidone, propamocarb, propiconazole, propineb, proquinazid, prothiocarb, prothioconazole, pyracarbolid, pyraclostrobin, pyrazole fungicides, pyrazophos, pyridine fungicides, pyridinitril, pyrifenox, pyrimethanil, pyrimidine fungicides, pyroquilon, pyroxychlor, pyroxyfur, pyrrole fungicides, quinacetol, quinazamid, quinconazole, quinoline fungicides, quinomethionate, quinone fungicides, quinoxaline fungicides, quinoxyfen, quintozene, rabenzazole, salicylanilide, silthiofam, silver, simeconazole, sodium azide, sodium bicarbonate[2][3], sodium orthophenylphenoxide, sodium pentachlorophenoxide, sodium polysulfide, spiroxamine, streptomycin, strobilurin fungicides, sulfonanilide fungicides, sulfur, sulfuryl fluoride, sultropen, TCMTB, tebuconazole, tecloftalam, tecnazene, tecoram, tetraconazole, thiabendazole, thiadifluor, thiazole fungicides, thicyofen, thifluzamide, thymol, triforine, thiocarbamate fungicides, thiochlorfenphim, thiomersal, thiophanate, thiophanate-methyl, thiophene fungicides, thioquinox, thiram, tiadinil, tioxymid, tivedo, tolclofos-methyl, tolnaftate, tolylfluanid, tolylmercury acetate, triadimefon, triadimenol, triamiphos, triarimol, triazbutil, triazine fungicides, triazole fungicides, triazoxide, tributyltin oxide, trichlamide, tricyclazole, tridemorph, trifloxystrobin, triflumizole, triforine, triticonazole, unclassified fungicides, undecylenic acid, uniconazole, uniconazole-P, urea fungicides, validamycin, valinamide fungicides, vinclozolin, voriconazole, zarilamid, zinc naphthenate, zineb, ziram, and/or zoxamide.

In some embodiments, the bioherbicide composition further comprises an herbicide component to afford an agricultural composition. In some embodiments, the herbicide component is a non-selective herbicide. In some embodiments, the herbicide component is a selective herbicide. Exemplary herbicides include, but are not limited to, acetochlor, alachlor, aminopyralid, atrazine, benoxacor, bromoxynil, carfentrazone, chlorsulfuron, clodinafop, clopyralid, dicamba, diclofop-methyl, dimethenamid, fenoxaprop, flucarbazone, flufenacet, flumetsulam, flumiclorac, fluroxypyr, glufosinate-ammonium, glyphosate, halosulfuron-methyl, imazamethabenz, imazamox, imazapyr, imazaquin, imazethapyr, isoxaflutole, quinclorac, MCPA, MCP amine, MCP ester, mefenoxam, mesotrione, metolachlor, s-metolachlor, metribuzin, metsulfuron-methyl, nicosulfuron, paraquat, pendimethalin, picloram, primisulfuron, propoxycarbazone, prosulfuron, pyraflufen ethyl, rimsulfuron, simazine, sulfosulfuron, thifensulfuron, topramezone, tralkoxydim, triallate, triasulfuron, tribenuron, triclopyr, trifluralin, 2,4-D, 2,4-D amine, 2,4-D ester and the like.

For an unlimited list of pesticides and herbicides, see “Farm Chemicals Handbook 2000, 2004” (Meister Publishing Co, Willoughby, Ohio), which is hereby incorporated by reference in its entirety.

In some embodiments, the agricultural composition contains any suitable liquid or dry pesticide and/or herbicidal component for application to fields and/or crops.

The described bioherbicide composition present in the agricultural composition can be applied with the application of a pesticide and/or herbicide component of the agricultural composition. The bioherbicide composition present in the agricultural composition can be applied prior to, subsequent to, or simultaneously with the application of the pesticide and/or herbicide component present in the agricultural composition.

In some embodiments, the bioherbicide composition is further combined with a fertilizer. The fertilizer can be a solid fertilizer, such as, but not limited to, a granular fertilizer, and the bioherbicide composition can be applied to the fertilizer as a liquid dispersion. The fertilizer can be in liquid form, and the bioherbicide composition can be mixed with the liquid fertilizer. The fertilizers can be selected from the group consisting of starter fertilizers, phosphate-based fertilizers, fertilizers containing nitrogen, fertilizers containing phosphorus, fertilizers containing potassium, fertilizers containing calcium, fertilizers containing magnesium, fertilizers containing boron, fertilizers containing chlorine, fertilizers containing zinc, fertilizers containing manganese, fertilizers containing copper, fertilizers containing urea and ammonium nitrite and/or fertilizers containing molybdenum materials. In some embodiments, the fertilizer is or contains urea, and/or ammonia, including anhydrous ammonia fertilizer. In some embodiments, the fertilizer comprises plant-available nitrogen, phosphorous, potassium, sulfur, calcium, magnesium or micronutrients. In some embodiments, the fertilizer is solid, granular, a fluid suspension, a gas, or a solutionized fertilizer. In some embodiments, the fertilizer comprises a micronutrient. A micronutrient is an essential element required by a plant in small quantities. In some embodiments, the fertilizer comprises a metal ion selected from the group consisting of: Fe, Mn, Mg, Zn, Cu, Ni, Mo, and Ca. In some embodiments, the fertilizer comprises gypsum, Kieserite Group member, potassium product, potassium magnesium sulfate, elemental sulfur, or potassium magnesium sulfate. Such fertilizers may be granular, liquid, gaseous, or mixtures (e.g., suspensions of solid fertilizer particles in liquid material).

In some embodiments, the bioherbicide composition present in the agricultural composition is combined with any suitable liquid or dry fertilizer for application to fields and/or crops.

The described bioherbicide composition present in the disclosed agricultural composition can be applied with the application of a fertilizer component. The bioherbicide composition present in the agricultural composition can be applied prior to, subsequent to, or simultaneously with the application of the fertilizer component present in the agricultural composition.

The amount of bioherbicide composition and pesticide component in the agricultural composition can vary. In some embodiments, the bioherbicide composition is present in an amount of from about 0.01% to about 99%, from about 10% to about 80%, from about 20% to about 70%, or from about 30% to about 60% by weight based on the total weight of the agricultural composition. In some embodiments, the pesticide component is present in an amount of from about 0.01% to about 99%, from about 10% to about 80%, from about 20% to about 70%, or from about 30% to about 60% by weight based on the total weight of the agricultural composition.

In some embodiments, the bioherbicide composition and the pesticide component are present in a ratio of from about 1:100 to about 100:1, from about 1:50 to about 50:1, from about 1:25 to about 25:1, from about 1:20 to about 20:1, from about 1:10 to about 10:1, from about 1:5 to about 5:1, from about 1:2 to about 2:1, or about 1:1 bioherbicide composition to pesticide component based on weight.

### C. Methods of Using the Compositions

In some embodiments, the bioherbicide compositions can be used directly. In other embodiments, the bioherbicide compositions are formulated in ways to make their use convenient in the context of productive agriculture.

In particular, the bioherbicide compositions and/or bioherbicide formulations as disclosed herein can be used in methods of reducing the germination of seeds of an invasive grass weed in a target area, the method comprising applying to the target area herbicidally effective amount of the bioherbicide composition or formulation thereof. In some embodiments, the method reduces the seed germination of invasive grass weeds in a target area by at least about 10%, about 20%, about 30%, about 40%, about 50%, or at least by about 55% compared to untreated seeds of invasive grass weeds in a target area. In some embodiments, the method inhibits the germination of seeds of invasive grass weeds in a target area of from about 1% to about 75%, from about from about 5% to about 70%, from about 10% to about 65%, from about 10% to about 60%, from about 15% to about 55%, from about 15% to about 55%, from about 20% to about 50%, from about 25% to about 50%, from about 30% to about 50%, from about 35% to about 50%, from about 40% to about 50%, or from about 45% to about 50, compared to untreated seeds of invasive grass weeds in a target area. In some embodiments, the method inhibits the germination of seeds of invasive grass weeds in a target area by no more than about 65%, about 60%, about 55%, about 50%, about 45%, about 40%, about 35%, about 30%, about 25%, about 20%, about 15%, about 10%, or no more than about 5% compared to untreated seeds of invasive grass weeds in a target area.

In some embodiments, the target area is in a grass patch, an agricultural field, a natural landscape, golf course, a road side, private rangelands, public rangelands, pastures, a broadacre row cropping system, a lawn, a garden, a vineyard, an orchard, a plantation, or a combination thereof.

In some embodiments, the bioherbicide composition and/or formulation thereof is applied to the soil and/or seeds of invasive grass weeds (prior to seed germination of invasive grass weeds) of the target area prior to planting wanted vegetation. Such a bioherbicide composition is referred to as a preplant bioherbicide composition, with respect to the wanted vegetation.

In some embodiments, the bioherbicide composition and/or formulation thereof is applied to the soil and/or seeds of invasive grass weeds (prior to seed germination of invasive grass weeds) of the target area prior to the germination of seeds of wanted vegetation. Such a bioherbicide composition is also referred to as a pre-germination bioherbicide composition, with respect to the wanted vegetation.

In some embodiments, the bioherbicide composition and/or formulation thereof is applied to the soil and/or seeds of invasive grass weeds (prior to seed germination of invasive grass weeds) of the target area after the crop has been planted (i.e., in the form of seeds) but before it germinates and/or emerges. Such a bioherbicide composition is referred to as a preemergent bioherbicide composition, with respect to the wanted vegetation. In such embodiments, the bioherbicide composition essentially does not affect the germination of the crop seeds. For example, in some embodiments, the germination of at least about 80%, about 85%, about 90%, about 91%, about 92%, about 93%, about 94%, about 95%, about 96%, about 97%, about 98%, about 99%, about 99.5%, about 99.5%, or about 100% of crop seeds are not affected by the presence of the bioherbicide composition.

Thus, in some embodiments, the bioherbicide composition or formulation is applied to the soil and/or seeds of invasive grass weeds (prior to seed germination of invasive grass weeds) of the target area containing plants of wanted vegetation. It would be understood that application of such a bioherbicide composition would leave the plants of any wanted vegetation essentially uninjured. It would be understood that the term “essentially uninjured” refers to an amount of injured plants of wanted vegetation that is no more than about 10%, 9%, 8%, 7%, 6%, 5%, 4%, 3%, 2%, or about 1% based on the total number of plants of wanted vegetation present in the target area after application of the bioherbicide composition.

In some embodiments, the bioherbicide composition is applied onto the soil of the target area containing invasive grass weed seeds and seeds of wanted vegetation. It would be understood that application of such a bioherbicide composition would leave the seeds of any wanted vegetation essentially uninjured, i.e., would not prevent germination and/or would not arrest germination. It would be understood that the term “essentially uninjured” refers to an amount of injured seeds of wanted vegetation that is no more than about 10%, 9%, 8%, 7%, 6%, 5%, 4%, 3%, 2%, or about 1% based on the total number of seeds of wanted vegetation present in the target area after application of the bioherbicide composition.

In some embodiments, the bioherbicide composition is applied to the soil days, weeks, or even months before planting the wanted vegetation and/or germination of seeds of the wanted vegetation. In some embodiments, the bioherbicide composition is applied at least about 1-12 months (or at least about 1, 2, 3, 4, 5, 6, 7, 8, 9, 10, 11 or about 12 months), at about least 1-10 months, at least about 1-8 months, at least about 1-6 months, at least about 1-4 months, or at least 1-3 months prior to planting plants of wanted vegetation or prior to the germination of seeds of the wanted vegetation.

In some embodiments, the bioherbicide composition is applied to the soil days, weeks, or even months before seed germination of invasive grass weeds. In some embodiments, the bioherbicide composition is applied at least about 1-12 months (or at least about 1, 2, 3, 4, 5, 6, 7, 8, 9, 10, 11 or about 12 months), at about least 1-10 months, at least about 1-8 months, at least about 1-6 months, at least about 1-4 months, or at least 1-3 months prior to seed germination of invasive grass weeds.

The number of applications of the bioherbicide composition as disclosed herein can vary depending on the type of invasive grass weed, the type of wanted vegetation, climate, and the like. A skilled person in the art would be aware of such factors and apply the bioherbicide composition accordingly. For example, in some embodiments, the bioherbicide composition or formulation thereof is applied at least 1-10 times (or at least 1, 2, 3, 4, 5, 6, 7, 8, 9 or 10 times) over a time frame of 1-6 months. In some embodiments, the bioherbicide composition or formulation thereof is applied weekly or monthly over a time frame of 1-12 months.

The timing of the application of the bioherbicide composition disclosed herein can vary depending on the type of invasive grass weed, the type of wanted vegetation, climate, and the like. A skilled person in the art would be aware of such factors and apply the bioherbicide composition accordingly.

Eradication of invasive weeds can be accomplished with the disclosed bioherbicide composition over a period of several years. In some embodiments, eradication of invasive weeds is accomplished over a period of about 2, 3, 4, 5, 6, 7, 8, 9, 10, 11, 12 years or longer.

The rate of application of bioherbicide composition or formulation thereof to treat a target area can vary within wide limits and depend on the nature of the soil, the method of application (pre- or postemergence; etc.), the type of wanted vegetation, the type(s) of invasive grass weed to be controlled, the prevailing climatic conditions, and other factors governed by the method of application, and the time of application. In some embodiments, the bioherbicide composition and/or formulation thereof can be applied at a rate of between about 0.1 to about 100 gallons/acre, about 1 to about 90 gallons/acre, about 10 to about 80 gallons/acre, 20 to about 70 gallons/acre, or from about 30 to about 60 gallons/acre.

The amount of the bioherbicide compositions and/or formulation thereof being applied to a target area may vary within wide limits and depend on the nature of the soil, the method of application (pre- or postemergence; etc.), the type of wanted vegetation, the invasive grass weed(s) type to be controlled, the prevailing climatic conditions, and other factors governed by the method of application, the time of application and the target crop, if applicable. In some embodiments, the bioherbicide composition is used in an amount of from about 1 to about 1,000 liters/hectare (L/ha), from about 100 to about 900 L/ha, from about 200 to about 800 L/ha, from about 250 to about 600 L/ha or from about 350 to about 500 L/ha. In some embodiments, the bioherbicide composition is used in an amount of from about 1 to about 500 liters/hectare (L/ha), from about 100 to about 500 L/ha, from about 150 to about 450 L/ha, from about 200 to about 400 L/ha, or is from about 250 to about 350 L/ha. In some embodiments, the bioherbicide composition is used in an amount of from about 100 to about 1,000 liters/hectare (L/ha), from about 200 to about 900 L/ha, from about 300 to about 800 L/ha, from about 400 to about 700 L/ha, or is from about 500 to about 650 L/ha.

In some embodiments, the bioherbicide composition and/or formulation thereof is used in an amount of from about 1 to about 500 kg/hectare (kg/ha), from about 10 to about 400 kg/ha, from about 20 to about 350 kg/ha, from about 25 to about 300 kg/ha, from about 50 to about 275 kg/ha, from about 75 to about 250 kg/ha, or from about 100 to about 200 kg/ha. In some embodiments, the bioherbicide composition and/or formulation thereof is used in an amount of from about 100 to about 500 kg/hectare (kg/ha), from about 150 to about 450 kg/ha, from about 200 to about 400 kg/ha, from about 250 to about 350 kg/ha, from about 200 to about 300 kg/ha, or from about 225 to about 275 kg/ha. In some embodiments, the bioherbicide composition and/or formulation thereof is used in an amount of from about 1 to about 300 kg/hectare (kg/ha), from about 10 to about 250 kg/ha, from about 25 to about 200 kg/ha, from about 50 to about 150 kg/ha, from about 75 to about 125 kg/ha, or from about 75 to about 100 kg/ha.

The herbicidal composition can be applied to the target area using application methods that are commonly used in agriculture. Exemplary application methods include, but are not limited to, fertigation, irrigation, drenching, dripping, spraying or a combination thereof. In some embodiments, the bioherbicide composition or formulation is applied using spraying. Exemplary spraying techniques include band application, broadcast application, directed application and spot application.

In some embodiments, the bioherbicide composition and/or formulation thereof is applied to the target area using broadcast application methods, which apply the bioherbicide composition and/or formulation thereof non-selectively to the soil over the entire target area. Broadcast application methods can be used for preplant bioherbicide compositions, pre-germination bioherbicide compositions and/or preemergent bioherbicide compositions (with respect to the wanted vegetation). Thus, in some embodiments, the bioherbicide composition and/or formulation thereof are applied to the soil of a target area using broadcast application methods for preplant bioherbicide compositions, pre-germination bioherbicide composition and/or preemergent bioherbicide compositions prior to emergence of the invasive grass weed.

In some embodiments, broadcast application methods are used for postemergence selective bioherbicide compositions (with respect to the wanted vegetation) and/or formulation thereof. In such broadcast application methods the selective postemergence bioherbicide compositions and/or formulation thereof are non-selectively applied to plants and/or plant parts of the wanted vegetation and the invasive grass weeds.

In some embodiments, the bioherbicide composition and/or formulation thereof are applied to the target area using band application methods, which apply the bioherbicide composition and/or formulations thereof in the form of narrow strips either directly over the row of cultivated crops, for example, or narrow strips between rows of cultivated crops. Band application methods use smaller amounts of bioherbicide composition and/or formulation thereof compared to broadcast application methods because the target area is much smaller. Band application methods can be used for postemergence selective bioherbicide compositions (with respect to the wanted vegetation) and/or formulation thereof. In some embodiments, the bioherbicide composition and/or formulation thereof is applied to the soil and/or plant parts of the wanted vegetation using this particular application method.

In some embodiments, the bioherbicide composition and/or formulation thereof is applied to the target area using direct application methods. In these types of applications, the target area typically is the area between the rows of cultivated crops and/or the area between individual plants of cultivated crops, where the bioherbicide composition and/or formulation thereof is being applied with little to no bioherbicide composition and/or formulation thereof being applied to the crop foliage. Direct application methods are used for postemergence bioherbicide compositions (with respect to the cultivated crops) where the invasive grass weeds have no germinated yet in the target area. In some embodiments, directed application methods of the bioherbicide composition and/or formulation are applied to the soil of one or more portions of the target area prior to germination of the invasive grass weeds.

In some embodiments, the bioherbicide composition and/or formulation thereof are applied to the target area using spot application methods, which apply the bioherbicide composition and/or formulation thereof being applied to small target areas where seeds of invasive grass weeds are present or are at risk to be present. Spot application methods can be used for preplant, pre-germination, preemergence and postemergence (with respect to the wanted vegetation) non-selective bioherbicide compositions. In some embodiments, the bioherbicide composition is applied using spot application methods to the soil of the target area prior to germination of the invasive grass weeds. In some embodiments, the bioherbicide composition is applied using spot application methods to the soil of one or more portions of the target area.

The temperature at which the bioherbicide composition and/or formulation thereof is applied can vary and generally depends on the stability of the ethylene biosynthesis inhibitor. For example, various strains of Pseudomonas fluorescens bacteria require cooler temperatures to survive, particularly Pseudomonas fluorescens strain D7. Thus, in some embodiments, the above methods are carried out at temperatures below about 25° C., about 24° C., about 23° C., about 22° C., about 21° C., about 20° C., about 19° C., about 18° C., about 17° C., about 16° C., about 15° C., about 14° C., about 13° C., about 12° C., about 11° C., about 10° C., about 9° C., about 8° C., about 7° C., about 6° C., about 5° C., about 4° C., about 3° C., about 2° C., about 1° C., or about 0° C. In some embodiments, the above methods are carried out at temperatures ranging from about 0° C. to about 25° C., from about 0° C. to about 20° C., from about 0° C. to about 15° C., from about 0° C. to about 12° C., from about 0° C. to about 10° C., from about 2° C. to about 10° C., from about 2° C. to about 8° C., or from about 4° C. to about 8° C.

The bioherbicide composition and/or formulation thereof can be applied using any known agricultural equipment that is known in the art to carry out such function. Exemplary agricultural equipment includes but is not limited to sprayers (e.g., boom sprayer, spot sprayer, high-volume spray truck, backpack sprayer, spray dusters), power-dusters, misters, blanket wipers, rope wick applicator, hand-held rope wick wiper, rotary and drop spreaders, and the like. A skilled person in the art would be aware of the agricultural equipment that would be suitable for a given bioherbicide composition and/or formulation thereof and application method.

Another method disclosed herein is directed to the preparation of seeds of wanted vegetation coated with the bioherbicide composition disclosed herein. Such methods comprise applying the bioherbicide composition or formulation disclosed herein to at least one or more seeds thereby coating a portion of the surface area of the seed(s) of wanted vegetation. In some embodiments, the applying step comprises spraying the bioherbicide composition in liquid form onto the surface of the seed(s). In some embodiments, the applying step comprises mixing the bioherbicide in liquid form with the seeds in a container such that a portions of the seed(s) are submerged in the liquid bioherbicide composition. In some embodiments, the portion of the surface area coated by the bioherbicide composition comprises at least about 50%, at least about 60%, at least about 70%, at least about 80%, at least about 90%, at least about 95%, or at least about 98% of the total surface area of the seed(s).

In some embodiments, the wanted vegetation includes, but is not limited to, plants and/or seeds of cultivated crops and/or forage grass.

In some embodiments, the plants and/or seeds of cultivated crops are selected from specialty crops, sugar crops, legumes and a combination thereof. In some embodiments, the plants and/or seeds of cultivated crops are specialty crops. Specialty crops include fruits and tree nuts, vegetables, culinary herbs and spices, medicinal herbs, horticulture crops, and a combination thereof. Specialty crops selected from fruits and nuts include almonds, apples, apricots, avocado, banana, blackberry, blueberry, breadfruit, cacao, cashew, citrus, cherimoya, cherry, chestnut, coconut, coffee, cranberry, currant, date, feijoa fig, filbert, gooseberry, grape, guava, kiwi, lychee, macadamia, mango, nectarine, olive, papaya, passion fruit, peach, pear, pecan, persimmon, pineapple, pistachio, plum, pomegranate, quince, raspberry, strawberry, Surinam cherry, walnut, and a combination thereof. Specialty crops selected from vegetables include artichoke, asparagus, bean snap, green lima, beet, broccoli, brussel sprouts, cabbage, cauliflower, celeriac, celery, collards, cucumber, edamame, eggplant, endive, garlic, horseradish, kohlrabi, leek, lettuce, melons, mustard greens, okra, peas, onion, opuntia, pepper, potato, pumpkin, radish, rhubarb, rutabaga, salsify, spinach, squash, sweet corn, sweet potato, Swiss chard, taro, tomato, tomatillo, turnip, watermelon, and a combination thereof. Specialty crops selected from culinary herbs and spices include ajwain, allspice, angelica, anise, annatto, artemisia, asafetida, basil, bay, bladder wrack, Bolivian coriander, borage, calendula, chamomile, candle nut, caper, caraway, cardamom, cassia, catnip, chervil, chicory, chive, cicely, cilantro, cinnamon, clary, cloves, comfrey, common rue, coriander, cress, cumin, curry, dill, fennel, fenugreek, file, fingerroot, French sorrel, galangal, ginger, hops, horehound, hyssop, lavender, lemon balm, lemon thyme, lovage, mace, mahlab, malabathrum, marjoram, mint, nutmeg, oregano, orris root, paprika, parsley, pepper, rocket (arugula), rosemary, rue, saffron, sage, savory, tarragon, thyme, turmeric, vanilla, wasabi, watercress, and a combination thereof. Specialty crops selected from medicinal herbs include artemisia, arum, astragalus, boldo, cananga, comfrey, coneflower, ephedra, fenugreek, feverfew, foxglove, Ginkgo biloba, ginseng, goat's rue, goldenseal, gypsywort, horehound, horsetail, lavender, yerba buena, liquorice, marshmallow, mullein, passion flower, pennyroyal, pokeweed, St. John's wort, senna, skullcap, sonchus, sorrel, stevia, witch hazel, wood betony, wormwood, yarrow, and a combination thereof. Specialty crops selected from horticulture crops include bedding plants, Christmas trees, cut flowers, honey, tea leaves, ornamental trees and shrubs, maple syrup, hops and a combination thereof.

In some embodiments, the specialty crop is a legume. Legumes include alfalfa, clover, beans, peas, chickpeas, lentils, lupins, mesquite, carob, soybeans, peanuts, and tamarind.

In some embodiments, the specialty crops is a sugar crop selected from sugar beets, sugar cane, and a combination thereof.

In some embodiments, the plants and/or seeds of cultivated crops are not genetically modified crops. In some embodiments, the plants and/or seeds of cultivated crops are genetically modified crops.

In some embodiments, the plants and/or seeds of forage grasses include, but are not limited to, Timothy, Smooth Bromegrass, Meadow Bromegrass, Orchardgrass, Reed Canarygrass, Tall Fescue, Meadow Fescue, Perennial Ryegrass, Kentucky Bluegrass, Snake River Wheatgrass, Idaho Fescue, Sandberg Bluegrass, Annual Ryegrass, Small Grains (e.g., barley, oats, rye, wheat), Texas Bluegrass, Bermudagrass, Bahiagrass, Buffalograss, Gamegrass, Gramagrass, Kleingrass, lovegrasses, Pearl Millet, Sorghum-sudan grasses, Bluestems (native and old world), Dallisgrass, Johnsongrass, Indiangrass, Italian Ryegrass, Quackgrass, Switchgrass, or any combination thereof.

In some embodiments, the plants and/or seeds of forage grasses are selected from the group consisting of Agrostis spp. (bentgrasses), Agrostis capillaris (common bentgrass), Agrostis stolonfera (creeping bentgrass), Andropogon hallii (sand bluestem), Arrhenatherum elatius (false oat-grass), Bothriochloa bladhii (Australian bluestem), Bothriochloa pertusa (hurricane grass), Brachiaria decumbens (Surinam grass), Brachiaria humidicola (koronivia grass), Bromus spp. (bromegrasses), Cenchrus ciliaris (Buffelgrass), Chloris gayana (Rhodes grass), Cynodon dactylon (bermudagrass), Dactylis glomerata (orchard grass), Echinochloa pyramidalis (antelope grass), Entolasia imbricate (bungoma grass), Festuca spp. (fescues), Festuca arundinacea (tall fescue), Festuca pratensis (meadow fescue), Festuca rubra (red fescue), Heteropogon contortus (black spear grass), Hymenachne amplexicaulis (West Indian marsh grass), Hyparrhenia rufa (jaragua), Leersia hexandra (southern cutgrass), Lolium spp. (ryegrasses), Lolium multiflorum (Italian ryegrass), Lolium perenne (perennial ryegrass), Megathyrsus maximus (Guinea grass), Melinis minutiflora (molasses grass), Paspalum conjugatum (carabao grass), Paspalum dilatatum (dallisgrass), Phalaris arundinacea (reed canarygrass), Phleum pratense (Timothy), Poa spp. (bluegrasses, meadow-grasses), Poa arachnifera (Texas bluegrass), Poa pratensis (Kentucky Bluegrass), Poa trivialis (rough bluegrass), Setaria sphacelata (African bristlegrass), Themeda triandra (kangaroo grass), Thinopyrum intermedium (intermediate wheatgrass), and a combination thereof.

The bioherbicide compositions and formulations disclosed herein are reduce seed germination of a wide variety of invasive grass weed species. Exemplary invasive grass weed species include, but are not limited to, invasive grass weed and/or seeds selected from the group consisting of Poa annua (annual bluegrass), Poa trivialis (roughstalk bluegrass), Bromus tectorum (downy brome; cheatgrass), crabgrass, goosegrass, dallisgrass, bahiagrass, jointed goatgrass (Aegilopus cylindrical L.), medusahead (Taeniatherum caput medusa (L.) Nevski), rattail fescue, perennial ryegrass, and combinations thereof.

### D. Examples

The following preparations and examples are given to enable those skilled in the art to more clearly understand and to practice the present invention. They should not be considered as limiting the scope of the invention, but merely as being illustrative and representative.

### Example 1: Application of Pseudomonas fluorescens strain D7 and 1-nethylcylcopropene (1-MCP) to Tall Fescue and Kentucky Bluegrass Protocol

Place 10 seeds on moistened filter paper in 100 mm petri dishes, with three petri dishes per treatment. Using a pipette, apply 0.01 mL of the solution (water for controls, Pseudomonas for treated) evenly over the top surface of each seed. For the ethylene inhibitor treatment, place a small aluminum weigh boat containing 1 mL inhibitor solution in the petri dish. Ethylene inhibitor solution should be replaced daily. Cover seeds with another sheet of moistened filter paper before closing the petri dish. As needed, moisten the filter paper throughout the experiment with 1 mL of water at a time. Allow plants to germinate and grow for 11 days, removing the filter paper on day 5. Record the number of seeds germinated each day. Image analysis may be used at the end of the experiment to record total root and shoot growth.

Two species: Tall Fescue and Kentucky Bluegrass

Three timings of Pseudomonas fluorescens strain D7 application: 0, 3, and 7 days after planting

Four seed treatments: water (control), Pseudomonas fluorescens strain D7, 1-MCP, Pseudomonas fluorescens strain D7 and 1-MCP combination

Twelve seeds/petri dish (TF), 40 seeds/petri dish (KB)×3 petri dishes/treatment combination

### Example 2: Application of Pseudomonas fluorescens strain D7 and 1-methylcylcopropene (1-MCP) to Cheatgrass

### Protocol:

Place 10 seeds on moistened filter paper in 100 mm petri dishes, with three petri dishes per treatment. Using a pipette, apply 0.01 mL of the solution (water for controls, Pseudomonas for treated) evenly over the top surface of each seed. For the ethylene inhibitor treatment, place a small aluminum weigh boat containing lmL inhibitor solution in the petri dish. Ethylene inhibitor solution should be replaced daily. Cover seeds with another sheet of moistened filter paper before closing the petri dish. As needed, moisten the filter paper throughout the experiment with 1 mL of water at a time. Allow plants to germinate and grow for 11 days, removing the filter paper on day 5. Record the number of seeds germinated each day. Image analysis may be used at the end of the experiment to record total root and shoot growth.

One species: Cheatgrass, Bromus tectorum

Three timings of Pseudomonas fluorescens strain D7 application: 0, 3, and 7 days after planting

Four seed treatments: water (control), Pseudomonas fluorescens strain D7, 1-MCP, Pseudomonas fluorescens strain D7 and 1-MCP combination

### Experiment Performed Two Times

Run 1: 12 seeds/dish, 1 petri dish/treatment combo

Run 2: 10 seeds/dish, 3 petri dishes/treatment combo

Summary of Results from Examples 1 and 2:

Pseudomonas fluorescens strain D7 alone did not affect germination in two turf species. Dormancy requirements likely play a role in Pseudomonas fluorescens strain D7 efficacy. It was observed that Pseudomonas fluorescens strain D7 application time strongly influences germination outcomes with early application being the most effective. These results are consistent with ethylene biosynthesis inhibition. The combination of Pseudomonas fluorescens strain D7+1-MCP has a synergistic effect.

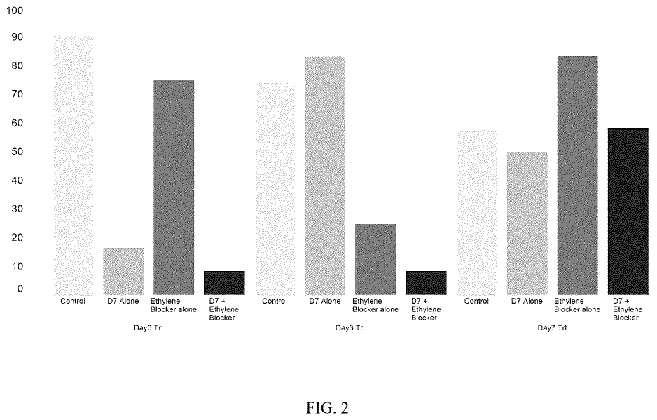

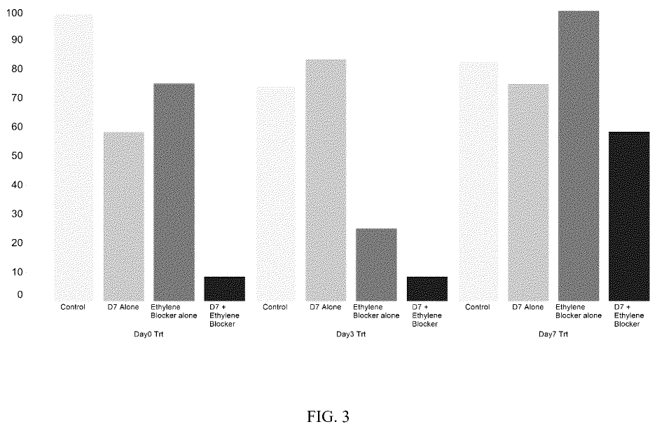

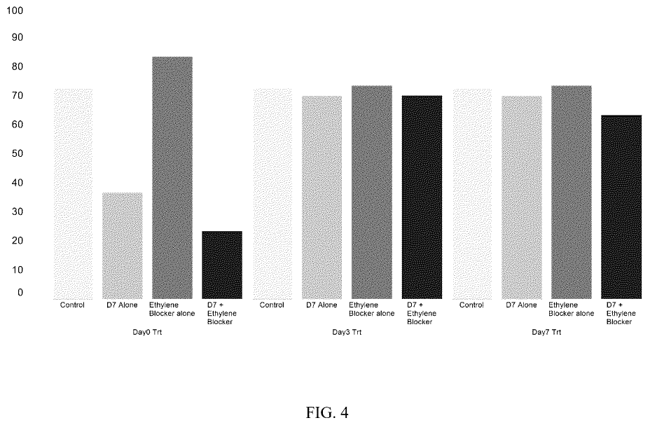

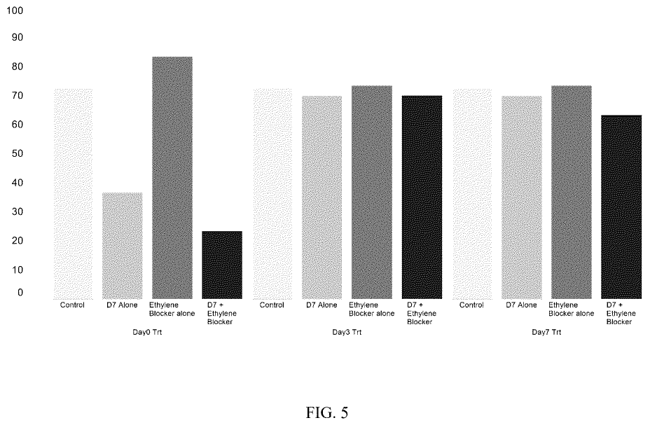

Inhibition of germination of the invasive weed, cheatgrass (Bromus tectorum) was observed in replicated trials. See FIGS. 2-5. No negative effects of these treatments on the germination of cultivated plants was observed, including Kentucky Bluegrass and Tall Fescue.

### Example 3: Colby Analysis of the Data Obtained in Example 2

A Colby Analysis was carried out for the data obtained in Example 2. The first data set is shown in Table 1 below, where cheatgrass (Bromus tectorum) was treated with Pseudomonas fluorescens strain D7 (D7) and 1-methylcyclopropene (1-MCP) alone or in combination at days 0, 3, and 7 of the treatment period. The percentage of germination was then determined at day 14 of the treatment period.

Table 1: Data of Example of Petri Dish Run 1 at Day 14.

| | | Trt_{—} | | | %_Germ_{—} |
|---|---|---|---|---|---|
| Species | Treatment | No | Rep | TrtDay | 14DAP |
| Bromus tectorum | Control | T01a | R0 | Day 0 | 100.00 |
| Bromus tectorum | Control | T01b | R0 | Day 3 | 75.00 |
| Bromus tectorum | Control | T01c | R0 | Day 7 | 83.33 |
| Bromus tectorum | D 7 Alone | T02a | R0 | Day 0 | 58.33 |
| Bromus tectorum | D 7 Alone | T02b | R0 | Day 3 | 83.33 |
| Bromus tectorum | D 7 Alone | T02c | R0 | Day 7 | 75.00 |
| Bromus tectorum | 1-MCP alone | T03a | R0 | Day 0 | 75.00 |
| Bromus tectorum | 1-MCP alone | T03b | R0 | Day 3 | 25.00 |
| Bromus tectorum | 1-MCP alone | T03c | R0 | Day 7 | 100.00 |
| Bromus tectorum | D 7 + 1-MCP | T04a | R0 | Day 0 | 8.33 |
| Bromus tectorum | D 7 + 1-MCP | T04b | R0 | Day 3 | 8.33 |
| Bromus tectorum | D 7 + 1-MCP | T04c | R0 | Day 7 | 58.33 |

TRL_No = Treatment number;
Rep = Repetition;
TrtDay = Treatment day;
%_Germ_14DAP = percentage of Germination at day 14

The Colby equation is a standard method for determining the presence of synergy. The Colby equation is as follows:

$$Expected value = ( X * Y ) / 100$$

wherein X and Y are the effects of the active agents (e.g., Pseudomonas fluorescens strain D7 (D7) and 1-methylcyclopropene (1-MCP)) applied alone (expressed as % of control).

The standard Colby equation interpretation is: If Observed Value is greater than the Expected Value, synergy exists. However, based on the goal of reducing germination in this study, the appropriate interpretation here is: If the Observed Value is less than the Expected Value, synergy.

Colby Equation Calculations at treatment day 14 when active agents were applied at day 0 of the experiment would be:

$$Expected value = ( X * Y ) / 100 , \\ wherein X is 83.33 and Y is 75.$$

TREATMENT ON DAY 0:

| | |
|---|---|
| Expected Percent Germ: | 43.7 |
| OBSERVED VALUE for D 7 + 1-MCP: | 8.3 |
| SYNERGY DETERMINATION: | SYNERGY |

Colby Equation Calculations at treatment day 14 when active agents were applied at day 3 of the experiment would be:

$$Expected value = ( X * Y ) / 100 , \\ wherein X is ( 58.33 / 75 ) and Y is ( 25 / 75 )$$

TREATMENT ON DAY 3:

| | |
|---|---|
| Expected Percent Germ: | 37.0 |
| OBSERVED VALUE for D 7 + 1-MCP: | 8.3 |
| SYNERGY DETERMINATION: | SYNERGY |

Colby Equation Calculations at treatment day 1 when active agents were applied at day 7 of the experiment would be:

$$Expected value = ( X * Y ) / 100 , \\ wherein X is ( 75. / 83.33 ) and Y is ( 100 / 83.33 )$$

TREATMENT ON DAY 7:

| | |
|---|---|
| Expected Percent Germ: | 108.0 |
| OBSERVED VALUE for D 7 + 1-MCP: | 58.3 |
| SYNERGY DETERMINATION: | SYNERGY |

The next Colby Analysis carried out was for the data obtained in Example 2, where cheatgrass (Bromus tectorum) was treated with Pseudomonas fluorescens strain D7 (D37) and 1-methylcyclopropene (1-MCP) alone or in combination at days 0, 3, and 7 of the treatment period, and the percentage of germination was then determined at day 11 of the treatment period.

TABLE 2
Data of Example of Petri Dish Run 2 at Day 11.

| Treatment | Trt_No | Rep | TrtDay | %_Germ11DAP | Trt Combo | Day 8% Germ Mean |
|---|---|---|---|---|---|---|
| Control | T01a | R1 | Day 0 | 100 | | |
| Control | T01a | R2 | Day 0 | 80 | | |
| Control | T01a | R3 | Day 0 | 90 | Control_Day 0 | 90.00 |
| Control | T01b | R1 | Day 3 | 90 | | |
| Control | T01b | R2 | Day 3 | 90 | | |
| Control | T01b | R3 | Day 3 | 90 | Control_Day 3 | 90.00 |
| Control | T01c | R1 | Day 7 | 90 | | |
| Control | T01c | R2 | Day 7 | 90 | | |
| Control | T01c | R3 | Day 7 | 90 | Control_Day 7 | 90.00 |
| D7 Alone | T02a | R1 | Day 0 | 60 | | |
| D7 Alone | T02a | R2 | Day 0 | 50 | | |
| D7 Alone | T02a | R3 | Day 0 | 60 | D7_Day 0 | 56.67 |
| D7 Alone | T02b | R1 | Day 3 | 100 | | |
| D7 Alone | T02b | R2 | Day 3 | 60 | | |
| D7 Alone | T02b | R3 | Day 3 | 70 | D7_Day 3 | 76.67 |
| D7 Alone | T02c | R1 | Day 7 | 90 | | |
| D7 Alone | T02c | R2 | Day 7 | 60 | | |
| D7 Alone | T02c | R3 | Day 7 | 70 | D7_Day 7 | 73.33 |
| 1-MCP alone | T03a | R1 | Day 0 | 80 | | |
| 1-MCP alone | T03a | R2 | Day 0 | 90 | | |
| 1-MCP alone | T03a | R3 | Day 0 | 90 | MCP_Day 0 | 86.67 |
| 1-MCP alone | T03b | R1 | Day 3 | 80 | | |
| 1-MCP alone | T03b | R2 | Day 3 | 80 | | |
| 1-MCP alone | T03b | R3 | Day 3 | 90 | MCP_Day 3 | 83.33 |
| 1-MCP alone | T03c | R1 | Day 7 | 100 | | |
| 1-MCP alone | T03c | R2 | Day 7 | 70 | | |
| 1-MCP alone | T03c | R3 | Day 7 | 80 | MCP_Day 7 | 83.33 |
| D7 + 1-MCP | T04a | R1 | Day 0 | 50 | | |
| D7 + 1-MCP | T04a | R2 | Day 0 | 30 | | |
| D7 + 1-MCP | T04a | R3 | Day 0 | 40 | D7 + MCP_Day 0 | 40.00 |
| D7 + 1-MCP | T04b | R1 | Day 3 | 70 | | |
| D7 + 1-MCP | T04b | R2 | Day 3 | 80 | | |
| D7 + 1-MCP | T04b | R3 | Day 3 | 90 | D7 +MCP_Day 3 | 80.00 |
| D7 + 1-MCP | T04c | R1 | Day 7 | 50 | | |
| D7 + 1-MCP | T04c | R2 | Day 7 | 70 | | |
| D7 + 1-MCP | T04c | R3 | Day 7 | 80 | D7 + MCP_Day 7 | 66.67 |

TRL_No = Treatment number; Rep = Repetition; TrtDay = Treatment day; %_Germ_11DAP = percentage of Germination at day 11

Colby Equation Calculations at treatment day 11 when active agents were applied at day 0 of the experiment would be:

$$Expected value = ( X * Y ) / 100 , \\ wherein X is ( 56.67 / 90 ) and Y is ( 86.67 / 90 )$$

TREATMENT ON DAY 0:

| | |
|---|---|
| Expected Percent Germ: | 60.6 |
| OBSERVED VALUE for D 7 + 1-MCP: | 40.0 |
| SYNERGY DETERMINATION: | SYNERGY |

Colby Equation Calculations at treatment day 11 when active agents were applied at day 3 of the experiment would be:

$$Expected value = ( X * Y ) / 100 , \\ wherein X is ( 76.67 / 90 ) and Y is ( 83.33 / 90 )$$

TREATMENT ON DAY 3:

| | |
|---|---|
| Expected Percent Germ: | 78.9 |
| OBSERVED VALUE for D 7 + 1-MCP: | 80.0 |
| SYNERGY DETERMINATION: | No |

Colby Equation Calculations at treatment day 11 when active agents were applied at day 7 of the experiment would be:

$$Expected value = ( X * Y ) / 100 , \\ wherein X is ( 73.33 / 90 ) and Y is ( 83.33 / 90 )$$

TREATMENT ON DAY 7:

| | |
|---|---|
| Expected Percent Germ: | 75.4 |
| OBSERVED VALUE for D 7 + 1-MCP: | 66.7 |
| SYNERGY DETERMINATION: | SYNERGY |

Next, a Colby Analysis carried out was for the data obtained in Example 2, where cheatgrass (Bromus tectorum) was treated with Pseudomonas fluorescens strain D7 (D37) and 1-methylcyclopropene (1-MCP) alone or in combination at days 0, 3, and 7 of the treatment period, and the percentage of germination was then determined at day 8 of the treatment period.

Table 2: Data of Example of Petri Dish Run 1 at Day 8.

TABLE 2
Data of Example of Petri Dish Run 1 at Day 8:

| Trt_No | Rep | Run | TrtDay | %_Germ_8DAP | Trt Combo | Day 8% Germ Mean |
|---|---|---|---|---|---|---|
| T01a | R0 | Run1 | Day 0 | 91.67 | | |
| T01a | R1 | Run2 | Day 0 | 100.0 | | |
| T01a | R2 | Run2 | Day 0 | 50.0 | | |
| T01a | R3 | Run2 | Day 0 | 70.0 | Control_Day 0 | 77.92 |
| T01b | R0 | Run1 | Day 3 | 75.00 | | |
| T01b | R1 | Run2 | Day 3 | 90.0 | | |
| T01b | R2 | Run2 | Day 3 | 60.0 | | |
| T01b | R3 | Run2 | Day 3 | 70.0 | Control_Day 3 | 73.75 |
| T01c | R0 | Run1 | Day 7 | 58.33 | | |
| T01c | R1 | Run2 | Day 7 | 70.0 | | |
| T01c | R2 | Run2 | Day 7 | 80.0 | | |
| T01c | R3 | Run2 | Day 7 | 70.0 | Control_Day 7 | 69.58 |
| T02a | R0 | Run1 | Day 0 | 16.67 | | |
| T02a | R1 | Run2 | Day 0 | 40.0 | | |
| T02a | R2 | Run2 | Day 0 | 30.0 | | |
| T02a | R3 | Run2 | Day 0 | 40.0 | D7_Day 0 | 31.67 |
| T02b | R0 | Run1 | Day 3 | 83.33 | | |
| T02b | R1 | Run2 | Day 3 | 100.0 | | |
| T02b | R2 | Run2 | Day 3 | 60.0 | | |
| T02b | R3 | Run2 | Day 3 | 50.0 | D7_Day 3 | 73.33 |
| T02c | R0 | Run1 | Day 7 | 50.00 | | |
| T02c | R1 | Run2 | Day 7 | 80.0 | | |
| T02c | R2 | Run2 | Day 7 | 60.0 | | |
| T02c | R3 | Run2 | Day 7 | 70.0 | D7_Day 7 | 65.00 |
| T03a | R0 | Run1 | Day 0 | 75.00 | | |
| T03a | R1 | Run2 | Day 0 | 80.0 | | |
| T03a | R2 | Run2 | Day 0 | 90.0 | | |
| T03a | R3 | Run2 | Day 0 | 80.0 | MCP_Day 0 | 81.25 |
| T03b | R0 | Run1 | Day 3 | 25.00 | | |
| T03b | R1 | Run2 | Day 3 | 80.0 | | |
| T03b | R2 | Run2 | Day 3 | 60.0 | | |
| T03b | R3 | Run2 | Day 3 | 80.0 | MCP_Day 3 | 61.25 |
| T03c | R0 | Run1 | Day 7 | 83.33 | | |
| T03c | R1 | Run2 | Day 7 | 90.0 | | |
| T03c | R2 | Run2 | Day 7 | 60.0 | | |
| T03c | R3 | Run2 | Day 7 | 70.0 | MCP_Day 7 | 75.83 |
| T04a | R0 | Run1 | Day 0 | 8.33 | | |
| T04a | R1 | Run2 | Day 0 | 30.0 | | |
| T04a | R2 | Run2 | Day 0 | 30.0 | | |
| T04a | R3 | Run2 | Day 0 | 10.0 | D7 + MCP_Day 0 | 19.58 |
| T04b | R0 | Run1 | Day 3 | 8.33 | | |
| T04b | R1 | Run2 | Day 3 | 80.0 | | |
| T04b | R2 | Run2 | Day 3 | 70.0 | | |
| T04b | R3 | Run2 | Day 3 | 60.0 | D7 + MCP_Day 3 | 54.58 |
| T04c | R0 | Run1 | Day 7 | 58.33 | | |
| T04c | R1 | Run2 | Day 7 | 50.0 | | |
| T04c | R2 | Run2 | Day 7 | 60.0 | | |
| T04c | R3 | Run2 | Day 7 | 80.0 | D7 + MCP_Day 7 | 62.08 |

TRL_No = Treatment number; Rep = Repetition; TrtDay = Treatment day; %_Germ_8DAP = percentage of Germination at day 8; Trt Combo = treatment Combo; Day 8% GermMean = Mean value of % Germination of all three repetitions.

Colby Equation Calculations at treatment day 8 when active agents were applied at day 3 of the experiment would be:

$$Expected value = ( X * Y ) / 100 , \\ wherein X is ( 31.67 / 77.92 ) and Y is ( 81.25 / 77.92 )$$

TREATMENT ON DAY 0:

| | |
|---|---|
| Expected Percent Germ: | 42.4 |
| OBSERVED VALUE for D 7 + 1-MCP: | 19.6 |
| SYNERGY DETERMINATION: | SYNERGY |

Colby Equation Calculations at treatment day 8 when active agents were applied at day 3 of the experiment would be:

$$Expected value = ( X * Y ) / 100 , \\ wherein X is ( 73.33 / 73.75 ) and Y is ( 61.25 / 73.75 )$$

TREATMENT ON DAY 3:

| | |
|---|---|
| Expected Percent Germ: | 82.6 |
| OBSERVED VALUE for D 7 + 1-MCP: | 54.6 |
| SYNERGY DETERMINATION: | SYNERGY |

Colby Equation Calculations at treatment day 8 when active agents were applied at day 7 of the experiment would be:

$$Expected value = ( X * Y ) / 100 , \\ wherein X is ( 65. / 69.58 ) and Y is ( 75.83 / 69.58 )$$

TREATMENT ON DAY 7:

| | |
|---|---|
| Expected Percent Germ: | 101.8 |
| OBSERVED VALUE for D 7 + 1-MCP: | 62.1 |
| SYNERGY DETERMINATION: | SYNERGY |

The above calculations demonstrate the synergy of the D7+1-MCP combination.

It will be apparent to those skilled in the art that various modifications and variations can be made in the present invention without departing from the scope or spirit of the invention. Other aspects of the invention will be apparent to those skilled in the art from consideration of the specification and practice of the invention disclosed herein. It is intended that the specification and examples be considered as exemplary only, with a true scope and spirit of the invention being indicated by the following claims.

1. A bioherbicide composition comprising
a strain of Pseudomonas fluorescens bacteria; and
an ethylene blocker, wherein the ethylene blocker is a compound of Formula (I) 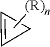
wherein n is an integer selected from 1, 2, 3 and 4; and
each R is independently selected from the group consisting of —H, —OH, —NH₂, halogen, substituted or unsubstituted (C1-C4) alkyl, substituted or unsubstituted (C1-C4) alkoxy, substituted or unsubstituted (C1-C4) carboxy, substituted or unsubstituted (C2-C6) alkenyl, substituted or unsubstituted phenyl, substituted or unsubstituted benzyl, and a combination thereof; and
wherein the strain of Pseudomonas fluorescens bacteria and the ethylene blocker are present in herbicidally effective amounts.

2. (canceled)

3. The bioherbicide composition of claim 1, wherein the strain of Pseudomonas flourescens bacteria is selected from the group consisting of AD31, AH4, E34, WH19, AII10, BT1, E24, TR33, TR44, TR46, A3422A, ALW38, G2Y, GTR12, GTR24, GTR40, HB14, HB26, HB32, ST22, SMK69, D7, ACK55, NKK78, MB906 and W36.

4. The bioherbicide composition of claim 1, wherein the strain of Pseudomonas fluorescens bacteria is D7 (NRRL B-18293).

5. The bioherbicide composition of claim 2, wherein n is 1; and/or R is unsubstituted (C1-C4) alkyl; and/or is methyl.

6. (canceled)

7. (canceled)

8. The bioherbicide composition of claim 1, wherein the ethylene blocker is 1-methylcyclopropene.

9. The bioherbicide composition of claim 1, wherein the strain of Pseudomonas fluorescens bacteria and the ethylene blocker are present in synergistically effective amounts.

10. The bioherbicide composition of claim 1, wherein the strain of Pseudomonas fluorescens bacteria is present in an herbicidally effective amount of from about 50% to about 99.9% based on the total weight of the bioherbicide composition; and/or the ethylene blocker is present in an herbicidally effective amount of from about 0.1% to about 50% based on the total weight of the bioherbicide composition.

11. (canceled)

12. (canceled)

13. The bioherbicide composition of claim 1, wherein the composition reduces germination of invasive grass weed seeds by at least about 30%.

14. A method of controlling the growth of invasive grass weed and/or reducing the germination of an invasive grass weed in a target area, the method comprising: (i) applying to the target area a herbicidally effective amount of a bioherbicide composition of claim 1.

15. (canceled)

16. (canceled)

17. (canceled)

18. (canceled)

19. (canceled)

20. The method of claim 14, wherein the bioherbicide composition is applied onto the soil of the target area; and/or mixed with the soil of the target area.

21. (canceled)

22. The method of claim 14, wherein the target area comprises invasive grass weed plants, invasive grass weed seeds, plants of wanted vegetation, seeds of wanted vegetation, or a combination thereof.

23. The method of claim 22, wherein the bioherbicide composition is applied onto the soil of the target area containing invasive grass weed seeds and plants of wanted vegetation.

24. The method of claim 22, wherein during the applying step the plants of the wanted vegetation are essentially uninjured.

25. The method of claim 14, wherein the bioherbicide composition is applied to the target area at a rate of from about 0.1 to about 100 gallons/acre.

26. (canceled)

27. The method of claim 14, wherein the target area is selected from a group consisting of a grass patch, an agricultural field, a natural landscape, golf course, a road side, private rangelands, public rangelands, pastures, a broadacre row cropping system, and combinations thereof.

28. The method of claim 14, wherein plants and/or seeds of wanted vegetation comprises cultivated crops, forage grasses, or combinations thereof, wherein
the cultivated crops are selected from:
specialty crops selected from fruits and nuts such as almonds, apples, apricots, avocado, banana, blackberry, blueberry, breadfruit, cacao, cashew, citrus, cherimoya, cherry, chestnut, coconut, coffee, cranberry, currant, date, feijoa, fig, filbert, gooseberry, grape, guava, kiwi, lychee, macadamia, mango, melons, nectarine, olive, papaya, passion fruit, peach, pear, pecan, persimmon, pineapple, pistachio, plum, pomegranate, quince, raspberry, strawberry, suriname cherry, walnut, watermelon; and/or
vegetables such as artichoke, asparagus, bean snap, green lima, beet, broccoli, brussels sprouts, cabbage, cauliflower, celeriac, celery, chive, collards, cucumber, edamame, eggplant, endive, garlic, horseradish, kohlrabi, leek, lettuce, mustard greens, okra, peas, onion, opuntia, parsley, parsnip, pepper, potato, pumpkin, radish, rhubarb, rutabaga, salsify, spinach, squash, sweet corn, sweet potato, swiss chard, taro, tomato, tomatillo, turnip; and/or
legumes selected from alfalfa, clover, beans, peas, chickpeas, lentils, lupins, mesquite, carob, soybeans, peanuts, and tamarind; and/or
the forage grasses are selected from Timothy, Smooth Bromegrass, Meadow Bromegrass, Orchardgrass, Reed Canarygrass, Tall Fescue, Meadow Feascue, Perennial Ryegrass, Kentucky Bluegrass, Snake River Wheatgrass, Idaho Fescue, Sandberg Bluegrass, Annual Ryegrass, Small Grains (e.g., barley, oats, rye, wheat), Texas Bluegrass, Bermudagrass, Bahiagrass, Buffalograss, Gamegrass, Gramasgrass, Kleingrass, lovegrasses, Pearl Millet, Sorghum-sudan grasses, Bluestems (native and old world), Dallisgrass, Johnsongrass, Indiangrass, Italian Ryegrass, Quackgrass, Switchgrass, and any combination thereof.

29. (canceled)

30. (canceled)

31. The method of claim 28, wherein the plants or seeds of cultivated crops are not genetically modified crops.

32. The method of claim 14, wherein the method arrests seed germination of invasive grass weed when during the applying step seeds of invasive grass weeds come into contact with the composition of claim 1.

33. The method of claim 14, wherein the invasive grass weed and/or seeds are selected from the group consisting of Poa annua (annual bluegrass), Poa trivialis (roughstalk bluegrass), Bromus tectorum (downy brome; cheatgrass), crabgrass, goosegrass, dallisgrass, bahiagrass, jointed goatgrass (Aegilopus cylindrical L.), medusahead (Taeniatherum caput medusa (L.) Nevski), rattail fescue, perennial ryegrass, and combinations thereof.

34. (canceled)

35. The method of claim 14, wherein the bioherbicide composition is in a form selected from a soluble liquid (SF), an emulsifiable concentrate (EC), a wettable powder (WP), a dry flowable (DF), a flowable (F), a water soluble powder (SP), an ultra-low-volume concentrate (ULV), a suspension concentrate (SC), an aqueous suspension (AS), a microencapsulated suspension (ME or MT), a capsule suspension (CS), a granule (G), a pellet (P), a ready to use formulation, a premix formulation, or a tank formulation.

36. (canceled)

37. The method of claim 14, wherein germination of invasive weed seeds are reduced by at least 40% compared to the germination of invasive weed seeds in an untreated target area.

38. The method of claim 14, wherein the bioherbicide composition further comprises a pesticide selected from fungicides, insecticides, acaricides, nematocide, molluscicide, miticides, plant growth regulators, and a combination thereof; and/or is further combined with a fertilizer.

39. (canceled)

40. (canceled)

41. (canceled)
